(19) United States
(12) Patent Application Publication
(10) Pub. No.: US 2018/0207044 A1
(43) Pub. Date: Jul. 26, 2018

(54) INTEGRATED PATIENT PLATFORM

(71) Applicant: Kona Medical, Inc., Bellevue, WA (US)

(72) Inventors: Arash Sabet, Walnut Creek, CA (US); David M. Perozek, Mercer Island, WA (US); Michael Gertner, Menlo Park, CA (US); Jimin Zhang, Bellevue, WA (US)

(73) Assignee: Kona Medical, Inc., Bellevue, WA (US)

(21) Appl. No.: 15/742,875

(22) PCT Filed: Jul. 6, 2015
(86) PCT No.: PCT/US15/39258

§ 371 Date: Jan. 8, 2018

(51) Int. Cl. A61G 13/08; A61G 13/10; A61G 13/12

(52) U.S. Cl. CPC A61G 13/08; A61G 13/104; A61G 2203/70; A61G 13/105; A61G 13/1205; A61G 13/126

(57) ABSTRACT

An integrated patient platform system and method for performing medical procedures below a patient's body is disclosed. In some embodiments, a superior level surface of an integrated patient platform is configured to support a patient lying in a prone or supine position, and an inferior level surface of the integrated patient platform is configured to support one or more medical procedure components. The superior level surface includes an aperture disposed therethrough. At least a portion of the aperture forms an examination window that is adjustable in size and position and configured to receive a portion of a patient over or in the examination window. A medical procedure component may be positioned on the inferior level surface to contact or otherwise interface with the portion of the patient positioned over or in the examination window.

### RELATED APPLICATION DATA

This application is the national phase of International Patent Application No. PCT/US2015/039258, filed on Jul. 6, 2015, pending. The entire disclosure of the above application is expressly incorporated by reference herein.

### TECHNICAL FIELD

This disclosure relates to patient interfaces and support systems. In particular, this disclosure relates to patient interfaces and support systems that facilitate access to a patient's underside during a medical procedure.

### BACKGROUND

Non-invasive and minimally-invasive procedures are increasingly being developed and performed to diagnose and treat medical conditions. In particular, transmitting energy waves from a distance to a target tissue inside a patient's body has become a frequently used and effective means for imaging and treatment. Medical ultrasonography, the non-invasive delivery of ultrasound waves to a patient, is currently used to visualize the structure of muscles, tendons, internal organs, and pathological lesions inside a body. Therapeutic delivery of ultrasound waves has been shown to be effective in a wide variety of therapeutic interventions, including lithotripsy, drug delivery, cancer therapy, thrombolysis, and nerve ablation. Non-invasive delivery of focused energy may allow for more efficient delivery of energy to the target tissue, improved cost effectiveness of treatment, minimized trauma to the patient's body, and improved recovery time.

Delivering energy over a distance requires targeting accuracy and precision. To achieve accuracy and precision, a patient must remain relatively still during the procedure, so it is desirable for the patient to be relaxed and comfortable. Additionally, either the patient or the energy-delivering apparatus must be maneuverable to achieve proper alignment between the energy-delivering apparatus and the target tissue. However, current systems are inadequate to meet these requirements. With current systems, the patient typically lies in a prone or supine position on an examination table or other patient support having a continuous surface. The medical apparatuses used to perform the medical procedure are suspended above the patient and/or located on one or more carts adjacent to the patient. The presence of bulky medical apparatuses suspended above the patient can be unsettling to the patient, making it difficult for the patient to relax. Suspended equipment and side carts can also significantly limit a clinical team's workspace and range of movements. Such equipment may create risks of knocking into or tripping on equipment within an examination room. When performing procedures on both a right side and left side of a patient's body, the side carts may need to be moved from one side of the patient to another, which can be inconvenient and time-consuming. Additionally, suspended apparatuses often require costly installations and are not portable between examination rooms. Moreover, the anatomy of the human body may limit the access window of any medical procedure component, such as an ultrasound transducer, making it difficult to reach a target region inside a patient's body from a position above and external to the patient.

Thus, there is a need for new and useful systems and methods for performing a medical procedure on a patient lying on a patient support surface. One or more embodiments described herein provide such new and useful systems and methods.

### SUMMARY

One aspect of the disclosure is directed to an integrated patient platform configured to support a patient thereon during a medical procedure. The integrated patient platform of various embodiments includes two detachable modules, the two detachable modules comprising a front module and a back module. The front and back modules are each independently movable. The front and back modules are positionable in a first, coupled configuration for clinical procedures and positionable in a second, separated configuration for transportation. In the first, coupled configuration, the front and back modules are in electrical communication and attached such that a top surface of the front module and a top surface of the back module together form a patient support surface, wherein an examination window is disposed within the patient support surface and sized to accommodate a target region of a patient on which a medical procedure is to be performed from below.

In some such embodiments, the examination window is a clinically optimized size.

In some embodiments, the front module comprises a therapy delivery component and the back module comprises an imaging component. In other embodiments, the back module comprises a therapy delivery component and the front module comprises an imaging component.

The back module may include a housing configured to store the therapy delivery component. In some such embodiments, a sidewall of the housing includes an aperture sized to enable horizontal movement of the therapy delivery component from a stored position within the housing to a functional position outside the housing. The integrated patient platform of some embodiments includes a cable management system within the housing, the cable management system configured to facilitate unobstructed movement of the therapy delivery component from the stored position to the functional position.

In some embodiments, the examination window is disposed within the top surface of the front module, and the front module further comprises a workbench surface positioned at a clinically optimized distance below the examination window. In such embodiments, the imaging component may include an imager and an imaging arm, the imaging arm being coupled to the front module and moveable within a workspace between the workbench surface and the examination window. Some such embodiments further include an optical tracking camera mounted within the front module or back module, the optical tracking camera configured to wirelessly communicate with an optical sensor in the imager and an optical sensor in the therapy delivery component. The front module or back module may be sized such that the optical tracking camera is positioned an optimized distance away from each of the therapy delivery component and the imager when the therapy delivery component and the imager are in a functional position on the workbench surface. In some embodiments, the optical tracking camera is positioned 40-160 cm away from each of the therapy delivery component and the imager when the therapy delivery component and the imager are in the functional position.

In some embodiments, the front module and back module perform complementary functions and are configured to coordinate the complementary functions when in electrical communication. In some embodiments, the front module and the back module perform independent functions. In some embodiments, the front module and back module are independently adjustable, serviceable, upgradeable, and/or exchangeable. In some embodiments, the electrical communication between the front and back modules is established automatically in the first, coupled configuration.

Another aspect of the disclosure is directed to a method of performing a medical procedure on a patient lying on a patient support surface. In various embodiments, the medical procedure is performed below the patient, and the method includes positioning two detachable modules in a coupled configuration, wherein the two detachable modules comprise a front module and a back module. In various embodiments, the front and back modules are movable between the coupled configuration for clinical procedures and a separated configuration for transportation, and in the coupled configuration, the front and back modules are in electrical communication and attached such that a top surface of the front module and a top surface of the back module together form a patient support surface. In various embodiments, an examination window is disposed within the patient support surface and sized to accommodate a target region of a patient on which a medical procedure is to be performed. The method of various embodiments further includes: positioning the patient on the patient support surface such that the target region is positioned within or over the examination window, positioning a procedure module such that the procedure module is below the examination window and directed upward toward the target region, and activating the procedure module to perform a medical procedure on the target region from below the patient.

Another aspect of the disclosure is directed to an integrated patient platform. In various embodiments, the integrated patient platform includes a superior level surface and an inferior level surface. The superior level surface of various embodiments is configured to support a patient and includes at least two movable shutters configured to adjust a size and location of an aperture under the patient, the aperture disposed within the superior level surface. The at least two movable shutters may be independently adjustable. The inferior level surface of various embodiments is located below the aperture and forms a work bench configured to support a clinical procedure module. The superior level may be spaced a clinically optimized distance above the inferior level surface.

In some such embodiments, the clinically optimized distance is 20-50 cm; in some embodiments, the clinically optimized distance is 30 cm.

In some embodiments, the clinical procedure module that the work bench is configured to support is selected from one or more of: a therapy delivery component, an imaging component, an optical tracking camera, and an optical sensor.

The integrated patient platform of some embodiments additionally includes an interior level positioned below the superior level and disposed on a shared horizontal plane with the inferior level. The interior level is positioned within a housing, optionally behind a housing door, and is configured to support the clinical procedure module during transport.

Yet another aspect of the disclosure is directed to an integrated patient platform that includes a patient support surface positioned along a horizontal plane and comprising an anterior portion and a posterior portion, wherein the anterior and posterior portions are spaced a fixed distance from each other and together define an examination window therebetween. In various embodiments, the integrated patient platform further includes: an anterior shutter coupled to the anterior portion; an anterior conveyor belt forming a loop around the anterior shutter; a posterior shutter coupled to the posterior portion; and a posterior conveyor belt forming a loop around the posterior shutter. The anterior and posterior shutters may each be movable along a plane parallel to the patient support surface and configured to extend into the examination window.

In some embodiments, the anterior shutter and posterior shutter are independently adjustable. The anterior and posterior shutters may be manually slideable, motorized and slideable, pneumatically actuated, or hydraulically actuated.

The integrated patient platform of some embodiments includes two or more anterior shutters and/or two or more posterior shutters. In some embodiments, the anterior conveyor belt is movably coupled to the anterior shutter such that the belt rotates when the anterior shutter moves along the plane. Additionally or alternatively, in some embodiments, the posterior conveyor belt is movably coupled to the posterior shutter such that the belt rotates when the posterior shutter moves along the plane.

The patient support surface of various embodiments is sized to accommodate a patient laying in a supine or prone position. In some embodiments, the integrated patient platform further includes an adjustable leg support positioned on the posterior surface of the patient support surface.

The integrated patient platform of some embodiments also includes a user interface configured to receive user inputs, wherein user inputs control the motion of the anterior and posterior shutters. The user interface may include a graphical user interface and a user input device. In some embodiments, the user input device is selected from a group consisting of: one or more keys, one or more buttons, a mouse, a keyboard, a toggle, a switch, a joystick, and a touchscreen.

An additional aspect of the disclosure is directed to an integrated patient platform that includes a patient support surface positioned along a horizontal plane. The patient support surface includes an anterior portion and a posterior portion, and the anterior and posterior portions are spaced a fixed distance from each other and together define an examination window therebetween. In various embodiments, the integrated patient platform further includes: a shutter slidable along a plane parallel to the patient support surface and configured to adjust a size of the examination window; a workbench surface disposed below the examination window along a plane parallel to the horizontal plane of the patient support surface; and a housing below the anterior portion or the posterior portion of the patient support platform. The housing may define a storage space configured to store a procedure module in a stored position. In various embodiments, the housing includes an aperture sized to enable horizontal movement of a procedure module from the stored position within the housing to a functional position on the workbench surface.

The integrated patient platform of some embodiments also includes a procedure module, such as for example, an imaging component and/or a therapy delivery component. Additionally or alternatively, the integrated patient platform of some embodiments includes a patient-positioning camera supported by the workbench surface and pointed upward toward the examination window. Additionally or alternatively, the integrated patient platform may include a cable management system within the housing, the cable management system configured to facilitate unobstructed movement of the procedure module from the stored position to the functional position. In some embodiments, the integrated patient platform includes an anterior shutter coupled to the anterior portion and a posterior shutter coupled to the posterior portion.

Still another aspect of the disclosure is directed to an integrated patient platform that includes a patient support surface positioned along a horizontal plane. The patient support surface includes an anterior portion and a posterior portion, and the anterior and posterior portions are spaced a fixed distance from each other and together define an examination window therebetween. The integrated patient platform of various embodiments further includes a shutter slidable along a plane parallel to the patient support surface, which is configured to adjust a size of the examination window. The integrated patient platform may include an anterior shutter coupled to the anterior portion and a posterior shutter coupled to the posterior portion. The integrated patient platform may also include a workbench surface disposed below the examination window along a plane parallel to the horizontal plane of the patient support surface, wherein the workbench surface is positioned 20-50 cm below the horizontal plane of the patient support surface. In some embodiments of the integrated patient platform, the workbench surface is positioned 30 cm below the horizontal plane of the patient support surface.

The integrated patient platform of some embodiments also includes a housing disposed below the patient support surface, wherein the housing is coupled to and supports the patient support surface. In such embodiments, the workbench surface and an edge of the shutter together define an open workspace. The open workspace may be further defined by sidewalls or side pillars of the housing. The integrated patient platform may further include a light source configured to illuminate the open workspace. The light source of some such embodiments includes one or more light emitting diodes disposed within one or more of the sidewalls or side pillars of the housing.

Another aspect of the disclosure is directed to a method of performing a medical procedure on a patient positioned in a supine or prone position. The medical procedure is performed below the patient and includes positioning a patient on an integrated patient platform. In various embodiments, the integrated patient platform on which the patient is positioned comprises: a patient support surface, which is positioned along a horizontal plane and includes an anterior portion and a posterior portion, wherein the anterior and posterior portions are spaced a fixed distance from each other and together define an examination window therebetween; a shutter slidable within the examination window along a plane parallel to the patient support surface; and a workbench surface disposed below the examination window along a plane parallel to the horizontal plane of the patient support surface, wherein the workbench surface and an edge of the shutter together define an open workspace. In various embodiments, the method further includes: adjusting the position of the shutter so as to position the workspace under a target region of the patient; positioning a procedure module within the workspace such that the procedure module is directed upward toward the target region; and activating the procedure module to perform a medical procedure on the target region from the workspace below the patient. The method of some embodiments further includes observing an image output of a patient-positioning camera, the patient-positioning camera disposed within the workspace, to determine a position of the patient relative to the workspace.

In some embodiments, adjusting the position of the shutter includes adjusting a posterior shutter and an anterior shutter. In some such embodiments, adjusting the posterior shutter and the anterior shutter includes one or more of: moving the shutters sequentially, moving the shutters simultaneously, moving the shutters in opposite directions, moving the shutters in the same direction, and adjusting the shutters from a preset position. The preset position may be, for example, a closed state in which the anterior shutter touches or nearly touches the posterior shutter or a default open state sized and positioned to accommodate the target region of an average patient.

In some embodiments, the medical procedure includes medical imaging. In some embodiments, the medical procedure additionally or alternatively includes the application of a therapeutic or analgesic treatment. In some such embodiments, the treatment includes therapeutic ultrasound. In such embodiments, the treatment may include, for example, ablation of a nerve at or near a renal artery. In some embodiments, the integrated patient platform is configured to apply therapeutic ultrasound to one or more of: a liver, spleen, pancreas, fat, muscle, vertebral nerve, celiac artery, mesenteric artery, ureter, renal pelvis, calyx, and any other structure in the abdomen. In some embodiments, the treatment comprises lithotripsy. The target region of the patient may be, for example, a nerve at or near a renal artery or a kidney stone.

A further aspect of the disclosure is directed to an integrated patient platform. The integrated patient platform of various embodiments includes a patient support surface configured to support a patient during a medical procedure, the patient support surface having an aperture disposed therein, wherein the aperture forms an examination window below a patient. The integrated patient platform of various embodiments also includes an imaging arm positioned below the examination window, wherein the imaging arm: is configured to securely receive an imaging transducer, is moveable in multiple degrees of freedom, and is upwardly spring-loaded such that the imaging arm, when positioned below a patient, is drawn upward to exert pressure onto the patient's body.

In some embodiments, the patient support surface is formed of a radiolucent material.

In some embodiments, at least two of the following orientations of the imaging arm are adjustable: pitch, yall, roll, vertical orientation, horizontal orientation, and angle. In some embodiments, the imaging arm is movable in six degrees of freedom. Such an imaging arm may be manually movable in six degrees of freedom. In other embodiments, movement of the imaging arm is controllable through a robotic control system having six degrees of motion control. The integrated patient platform of some embodiments also includes a motor coupled to the imaging arm, wherein the motor is configured to drive automated position adjustment in at least one of the six degrees of freedom.

In some embodiments, the imaging arm includes a constant force spring to spring-load the imaging arm. Such an imaging arm may be spring-loaded with 1-12 lbs. of force.

In some embodiments, the integrated patient platform also includes a lock configured to restrict each degree of freedom of the imaging arm and fix the orientation of the imaging arm in space. The lock of some embodiments is configured to fix the orientation of the imaging arm with a single user input. The user input may be, for example, a push of a button. In some embodiments, the lock is a mechanical lock integrated into the imaging arm. The imaging arm may be configured to lock in a fixed position during operation of a treatment module.

The integrated patient platform of some embodiments additionally or alternatively includes the imaging transducer and a remote targeting monitor, wherein the imaging transducer is communicatively coupled to the remote targeting monitor. In some such embodiments, a virtual treatment region can be projected from the imaging transducer to the remote targeting monitor. The imaging transducer may be removably coupled to the imaging arm.

Additionally or alternatively, in some embodiments, the integrated patient platform also includes an optical tracking camera. In some such embodiments, the imaging arm further includes a first optical sensor disposed thereon, and the optical tracking camera is configured to wirelessly communicate with the first optical sensor. Such embodiments may also include a therapy module having a second optical sensor disposed thereon, wherein the optical tracking camera is further configured to wirelessly communicate with the second optical sensor.

In some embodiments, the integrated patient platform additionally or alternatively includes a therapy module, wherein the therapy module and the imaging arm are configured to be moveable together by a single operator. The therapy module may be moveable via a motorized mechanism. In some embodiments, the integrated patient platform is configured to communicate a relative position of the imaging transducer and the therapy module to enable positioning of the imaging transducer and the therapy module relative to one another. The relative position may be communicated on an electronic screen and/or via an audible output.

An integrated patient platform configured to support a patient thereon during a medical procedure, includes: two detachable modules, the two detachable modules comprising a front module and a back module, wherein: the front and back modules are each independently movable, the front and back modules are positionable in a first, coupled configuration for clinical procedures and positionable in a second, separated configuration for transportation, and in the first, coupled configuration, the front and back modules are in electrical communication and attached such that a top surface of the front module and a top surface of the back module together form a patient support surface, wherein an examination window is disposed within the patient support surface and sized to accommodate a target region of a patient on which a medical procedure is to be performed from below.

Optionally, the examination window is a clinically optimized size.

Optionally, the front module comprises a therapy delivery component and the back module comprises an imaging component.

Optionally, the back module comprises a therapy delivery component and the front module comprises an imaging component.

Optionally, the back module comprises a housing configured to store the therapy delivery component, and wherein a sidewall of the housing includes an aperture sized to enable horizontal movement of the therapy delivery component from a stored position within the housing to a functional position outside the housing.

Optionally, the integrated patient platform further includes a cable management system within the housing, the cable management system configured to facilitate unobstructed movement of the therapy delivery component from the stored position to the functional position.

Optionally, the examination window is disposed within the top surface of the front module, and wherein the front module further comprises a workbench surface positioned at a clinically optimized distance below the examination window.

Optionally, the imaging component comprises an imager and an imaging arm, the imaging arm being coupled to the front module and moveable within a workspace between the workbench surface and the examination window.

Optionally, the integrated patient platform further includes an optical tracking camera mounted within the front module or back module, the optical tracking camera configured to wirelessly communicate with an optical sensor in the imager and an optical sensor in the therapy delivery component.

Optionally, the front module or back module is sized such that the optical tracking camera is positioned an optimized distance away from each of the therapy delivery component and the imager when the therapy delivery component and the imager are in a functional position on the workbench surface.

Optionally, the optical tracking camera is positioned 40-160 cm away from each of the therapy delivery component and the imager when the therapy delivery component and the imager are in the functional position.

Optionally, the front module and back module perform complementary functions and are configured to coordinate the complementary functions when in electrical communication.

Optionally, the front module and the back module perform independent functions.

Optionally, the front module and back module are independently adjustable, serviceable, upgradeable, or exchangeable.

Optionally, the electrical communication between the front and back modules is established automatically in the first, coupled configuration.

An integrated patient platform includes: a superior level surface; and an inferior level surface, wherein the superior level surface is configured to support a patient and includes at least two movable shutters configured to adjust a size and location of an aperture under the patient, the aperture disposed within the superior level surface, wherein the inferior level is located below the aperture and forms a work bench configured to support a clinical procedure module, and wherein the superior level is spaced a clinically optimized distance above the inferior level surface.

Optionally, the clinically optimized distance is 20-50 cm.

Optionally, the clinically optimized distance is 30 cm.

Optionally, the clinical procedure module that the work bench is configured to support is selected from one or more of: a therapy delivery component, an imaging component, an optical tracking camera, and an optical sensor.

Optionally, the at least two movable shutters are independently adjustable.

Optionally, the integrated patient platform further includes an interior level positioned below the superior level and disposed on a shared horizontal plane with the inferior level.

Optionally, the interior level is positioned within a housing behind a housing door and is configured to support the clinical procedure module during transport.

An integrated patient platform includes: a patient support surface positioned along a horizontal plane and comprising an anterior portion and a posterior portion, wherein the anterior and posterior portions are spaced a fixed distance from each other and together define an examination window therebetween; an anterior shutter coupled to the anterior portion; an anterior conveyor belt forming a loop around the anterior shutter; a posterior shutter coupled to the posterior portion; and a posterior conveyor belt forming a loop around the posterior shutter; wherein the anterior and posterior shutters are each movable along a plane parallel to the patient support surface and are configured to extend into the examination window.

Optionally, the anterior shutter and posterior shutter are independently adjustable.

Optionally, the integrated patient platform comprises two or more anterior shutters.

Optionally, the integrated patient platform comprises two or more posterior shutters.

Optionally, the anterior conveyor belt is movably coupled to the anterior shutter such that the belt rotates when the anterior shutter moves along the plane.

Optionally, the posterior conveyor belt is movably coupled to the posterior shutter such that the belt rotates when the posterior shutter moves along the plane.

Optionally, the patient support surface is sized to accommodate a patient laying in a supine or prone position.

Optionally, the integrated patient platform further includes an adjustable leg support positioned on the posterior surface of the patient support surface.

Optionally, the anterior and posterior shutters are: manually slideable, motorized and slideable, pneumatically actuated, or hydraulically actuated.

Optionally, the integrated patient platform further includes a user interface configured to receive user inputs, wherein user inputs control the motion of the anterior and posterior shutters.

Optionally, the user interface comprises a graphical user interface and a user input device.

Optionally, the user input device is selected from a group consisting of: one or more keys, one or more buttons, a mouse, a keyboard, a toggle, a switch, a joystick, and a touchscreen.

An integrated patient platform includes: a patient support surface positioned along a horizontal plane and comprising an anterior portion and a posterior portion, wherein the anterior and posterior portions are spaced a fixed distance from each other and together define an examination window therebetween; a shutter slidable along a plane parallel to the patient support surface and configured to adjust a size of the examination window; a workbench surface disposed below the examination window along a plane parallel to the horizontal plane of the patient support surface; and a housing below the anterior portion or the posterior portion of the patient support platform, wherein the housing defines a storage space configured to store a procedure module in a stored position, and wherein the housing includes an aperture sized to enable horizontal movement of a procedure module from the stored position within the housing to a functional position on the workbench surface.

Optionally, the integrated patient platform further includes the procedure module.

Optionally, the procedure module is an imaging component.

Optionally, the procedure module is a therapy delivery component.

Optionally, the integrated patient platform further includes a patient-positioning camera supported by the workbench surface and pointed upward toward the examination window.

Optionally, the integrated patient platform further includes a cable management system within the housing, the cable management system configured to facilitate unobstructed movement of the procedure module from the stored position to the functional position.

Optionally, the integrated patient platform comprises an anterior shutter coupled to the anterior portion and a posterior shutter coupled to the posterior portion.

An integrated patient platform includes: a patient support surface positioned along a horizontal plane and comprising an anterior portion and a posterior portion, wherein the anterior and posterior portions are spaced a fixed distance from each other and together define an examination window therebetween; a shutter slidable along a plane parallel to the patient support surface and configured to adjust a size of the examination window; and a workbench surface disposed below the examination window along a plane parallel to the horizontal plane of the patient support surface, wherein the workbench surface is positioned 20-50 cm below the horizontal plane of the patient support surface.

Optionally, the workbench surface is positioned 30 cm below the horizontal plane of the patient support surface.

Optionally, the integrated patient platform comprises an anterior shutter coupled to the anterior portion and a posterior shutter coupled to the posterior portion.

Optionally, the integrated patient platform further includes a housing disposed below the patient support surface, wherein the housing is coupled to and supports the patient support surface.

Optionally, the workbench surface and an edge of the shutter together define an open workspace.

Optionally, the open workspace is further defined by sidewalls or side pillars of the housing.

Optionally, the integrated patient platform further includes a light source configured to illuminate the open workspace.

Optionally, the light source comprises one or more light emitting diodes disposed within one or more of the sidewalls or side pillars of the housing.

An integrated patient platform includes: a patient support surface configured to support a patient during a medical procedure, the patient support surface having an aperture disposed therein, wherein the aperture forms an examination window below a patient; and an imaging arm positioned below the examination window, wherein the imaging arm: is configured to securely receive an imaging transducer, is moveable in multiple degrees of freedom, and is upwardly spring-loaded such that the imaging arm, when positioned below a patient, is drawn upward to exert pressure onto the patient's body.

Optionally, the imaging arm is movable in six degrees of freedom.

Optionally, the integrated patient platform further includes a motor coupled to the imaging arm, wherein the motor is configured to drive automated position adjustment in at least one of the six degrees of freedom.

Optionally, at least two of the following orientations of the imaging arm are adjustable: pitch, yall, roll, vertical orientation, horizontal orientation, and angle.

Optionally, the imaging arm comprises a constant force spring to spring-load the imaging arm.

Optionally, the imaging arm is spring-loaded with 1-12 lbs. of force.

Optionally, the integrated patient platform further includes a lock configured to restrict each degree of freedom of the imaging arm and fix the orientation of the imaging arm in space.

Optionally, the imaging arm is configured to lock in a fixed position during operation of a treatment module.

Optionally, the integrated patient platform further includes the imaging transducer and a remote targeting monitor, wherein the imaging transducer is communicatively coupled to the remote targeting monitor.

Optionally, a virtual treatment region can be projected from the imaging transducer to the remote targeting monitor.

Optionally, the imaging transducer is removably coupled to the imaging arm.

Optionally, the integrated patient platform further includes an optical tracking camera.

Optionally, the imaging arm further comprises a first optical sensor disposed thereon, and wherein the optical tracking camera is configured to wirelessly communicate with the first optical sensor.

Optionally, the integrated patient platform further includes a therapy module, the therapy module having a second optical sensor disposed thereon, wherein the optical tracking camera is further configured to wirelessly communicate with the second optical sensor.

Optionally, the integrated patient platform further includes a therapy module, wherein the therapy module and the imaging arm are configured to be moveable together by a single operator.

Optionally, the therapy module is moveable via a motorized mechanism.

Optionally, the integrated patient platform is configured to communicate a relative position of the imaging transducer and the therapy module to enable positioning of the imaging transducer and the therapy module relative to one another.

### BRIEF DESCRIPTION OF THE DRAWINGS

The foregoing is a summary, and thus, necessarily limited in detail. The above-mentioned aspects, as well as other aspects, features, and advantages of the present technology will now be described in connection with various embodiments, with reference made to the following accompanying drawings:

FIGS. 1A-1C illustrate a side view, a rear perspective view, and a front perspective view, respectively, of one embodiment of an integrated patient platform system;

FIG. 2A illustrates a side view of one embodiment of an integrated patient platform, with a front module shown coupled to a back module;

FIG. 2B illustrates a perspective view of one embodiment of an integrated patient platform, with a front module shown decoupled from a back module;

FIG. 3 illustrates a perspective view of one embodiment of a front module of an integrated patient platform;

FIG. 4A illustrates a perspective view of one embodiment of an integrated patient platform having four movable shutters shown in a closed configuration;

FIG. 4B illustrates a perspective view of one embodiment of an integrated patient platform having four movable shutters shown in a partially retracted configuration;

FIG. 4C illustrates a perspective view of one embodiment of an integrated patient platform having two movable shutters shown in a fully retracted configuration and two movable shutters shown in a closed configuration;

FIG. 4D illustrates a perspective view of one embodiment of an integrated patient platform having four movable shutters shown in a fully retracted configuration;

FIG. 5 illustrates a perspective view of one embodiment of an imaging component of an integrated patient platform;

FIGS. 6A and 6B illustrate a partial side view and top perspective view, respectively, of one embodiment of an integrated patient platform with one embodiment of a therapy delivery component and imaging component positioned in a workspace of the integrated patient platform;

FIGS. 7A and 7B illustrate perspective views of one embodiment of a back module of an integrated patient platform;

FIG. 8 illustrates a partial perspective view of one embodiment of an integrated patient platform having a cable management system;

FIG. 9 illustrates a partial perspective view of one embodiment of an integrated patient platform having an optical tracking system; and

FIG. 10 illustrates a flow chart of one embodiment of a method of performing a medical procedure on a patient lying on a patient support surface.

The illustrated embodiments are merely examples and are not intended to limit the claimed invention.

### DETAILED DESCRIPTION

The following description of the preferred embodiments is not intended to limit the claimed invention to these preferred embodiments, but rather to enable any person skilled in the art to make and use the claimed invention. Other embodiments may be utilized and modifications may be made without departing from the spirit or the scope of the subject matter presented herein. Aspects of the disclosure, as described and illustrated herein, can be arranged, combined, and designed in a variety of different configurations, all of which are explicitly contemplated and form part of this disclosure.

Throughout and within this specification, one or more publications may be referenced to more fully describe the state of the art. The disclosures of each of these references are incorporated herein by reference in their entireties as though they also form part of this disclosure.

Unless otherwise defined, each technical or scientific term used herein has the same meaning as commonly understood by one of ordinary skill in the art to which this disclosure belongs.

Disclosed herein are systems and methods for performing a medical procedure below a patient positioned in a supine or prone position.

The medical procedure may be non-invasive or minimally invasive. The medical procedure may include medical imaging (e.g., plain X-ray, computed tomography, magnetic resonance imaging, or ultrasound), for example, to view or examine one or more muscles, organs, or bone structures of a patient. The medical procedure may include a catheterization procedure, delivery of one or more injections, delivery of a therapeutic treatment, delivery of an analgesic treatment, or any other type of medical procedure. In some embodiments, the medical procedure includes ultrasonic imaging and/or therapy. In some embodiments, the medical procedure includes ablation of a nerve at or near a renal artery. Alternatively or additionally, the medical procedure may include applying therapeutic ultrasound to one or more of: a liver, spleen, pancreas, fat, muscle, vertebral nerve, celiac artery, mesenteric artery, ureter, renal pelvis, calyx, and/or any other structure in the abdominal or torso region. In some embodiments, the medical procedure includes lithotripsy.

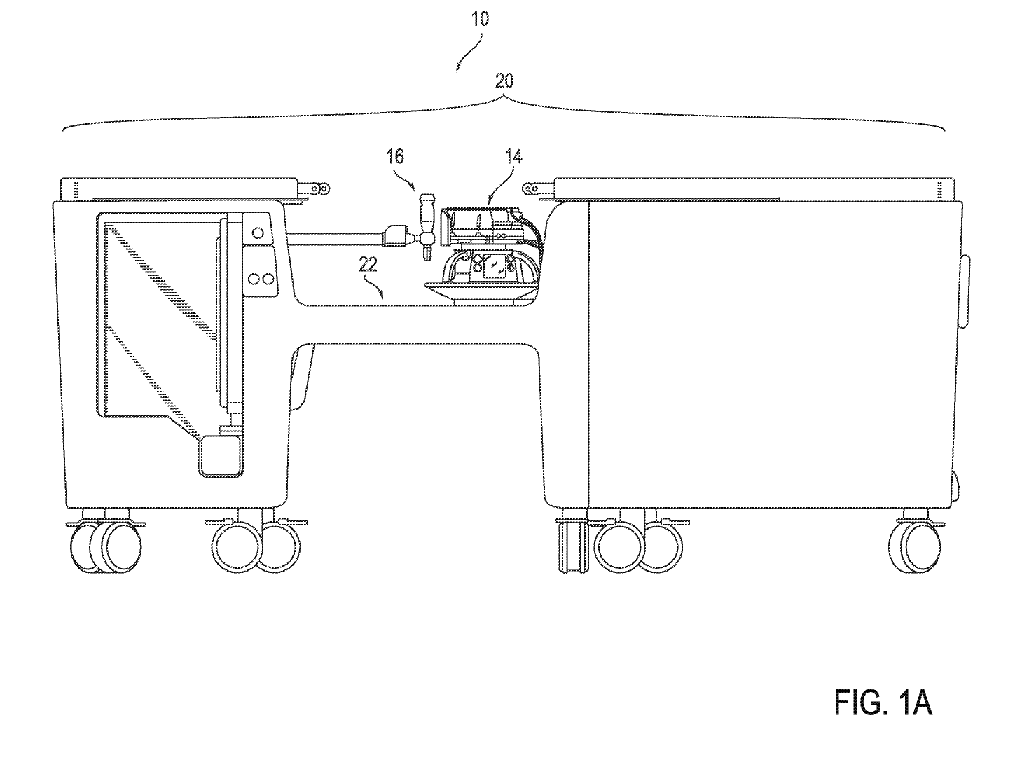

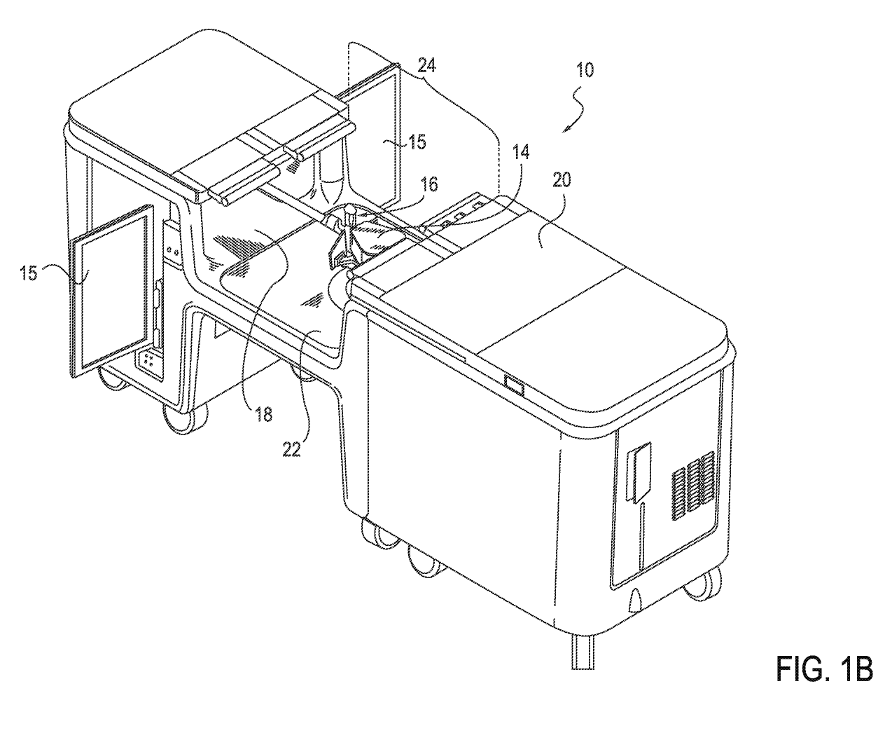

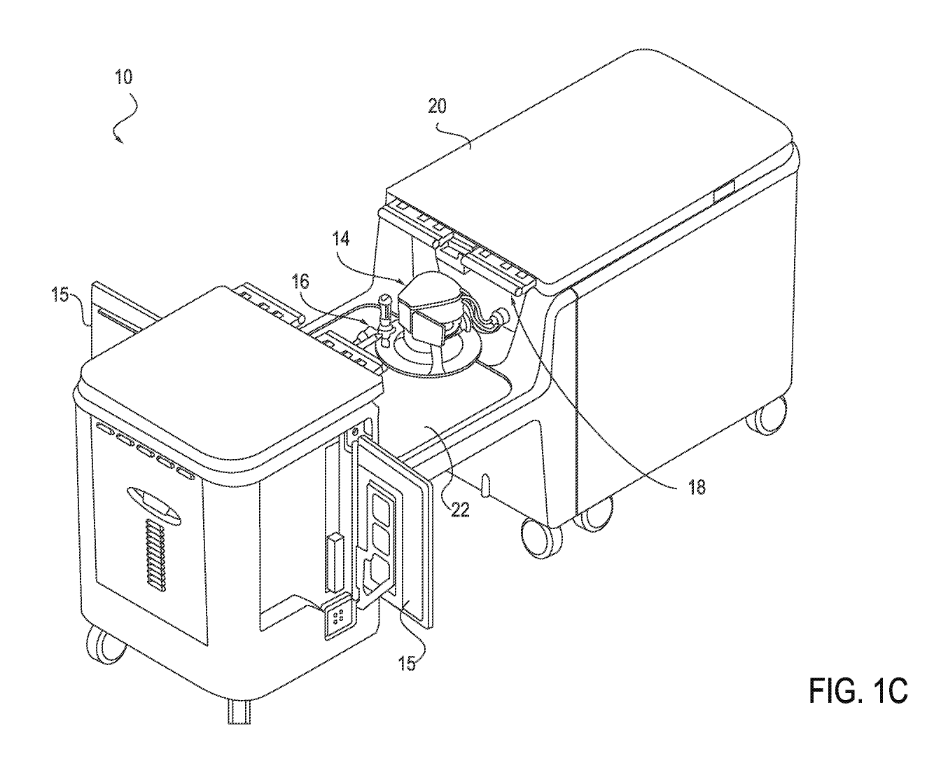

FIGS. 1A-1C illustrate various views of one embodiment of an integrated patient platform system 10 configured for performing one or more medical procedures below a patient. In some embodiments, as shown in FIGS. 1A-1C, a system 10 for performing a medical procedure below a patient includes an integrated patient platform formed of two detachable modules. When attached together, top surfaces of the two modules may together form a support surface 20 on which a patient can rest in a supine or prone position. In some embodiments, the system further includes one or more computing stations, display screens 15, a therapy delivery component 14, an imaging component 16, an optical tracking system (not visible), storage space 18, and/or a cable management system (not visible).

In various embodiments, the system is configured to enable the performance of medical procedures below a patient's body. In some embodiments, a superior (i.e., top) level surface 20 of the integrated patient platform (also referred to as the patient support surface) is configured to support a patient lying in a prone or supine position, and an inferior (i.e., lower) level surface 22 of the integrated patient platform is configured to support one or more medical procedure components. In various embodiments, the superior level surface 20 includes an aperture 24 disposed therethrough, as shown in FIG. 1B. At least a portion of the aperture 24 may form an examination window that is adjustable in size and position and configured to receive a portion of a patient's underside over or in the examination window. In various embodiments, a medical procedure component on the inferior level surface 22 can be positioned to contact or otherwise interface with the portion of the patient positioned over or in the examination window. Such a system configuration facilitates delivery of therapy to, and/or imaging of, a target region of a patient positioned on the integrated patient platform.

In some embodiments, the system 10 is configured to deliver ultrasonic energy to treat and/or image a target region of a patient. While various embodiments included herein describe using the system for medical ultrasonic applications, the system can additionally or alternatively be used for any suitable applications, clinical or otherwise.

In some embodiments, the patient is positioned in a supine position. Positioning a patient in a supine position on the integrated patient platform facilitates underside access to one or more target regions on or near a patient's back side, for example, one or both kidneys, one or more nerves surrounding the renal artery, the spinal cord or column, and/or one or more other bone, organ, or muscle structures. In some embodiments, the patient is positioned in a prone position. Positioning a patient in a prone position on the integrated patient platform facilitates underside access to one or more target regions on or near a patient's front side, for example, one or both lungs, the heart, the stomach, one or more segments of intestines, one or more breasts, one or more ribs, and/or one or more other bone, organ, or muscle structures.

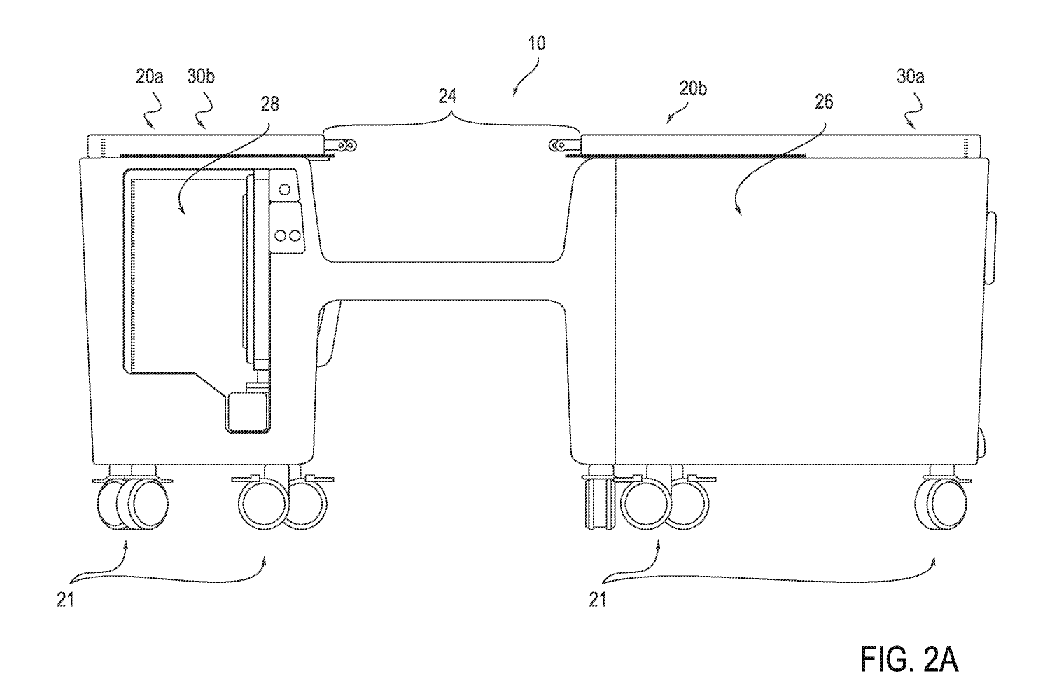

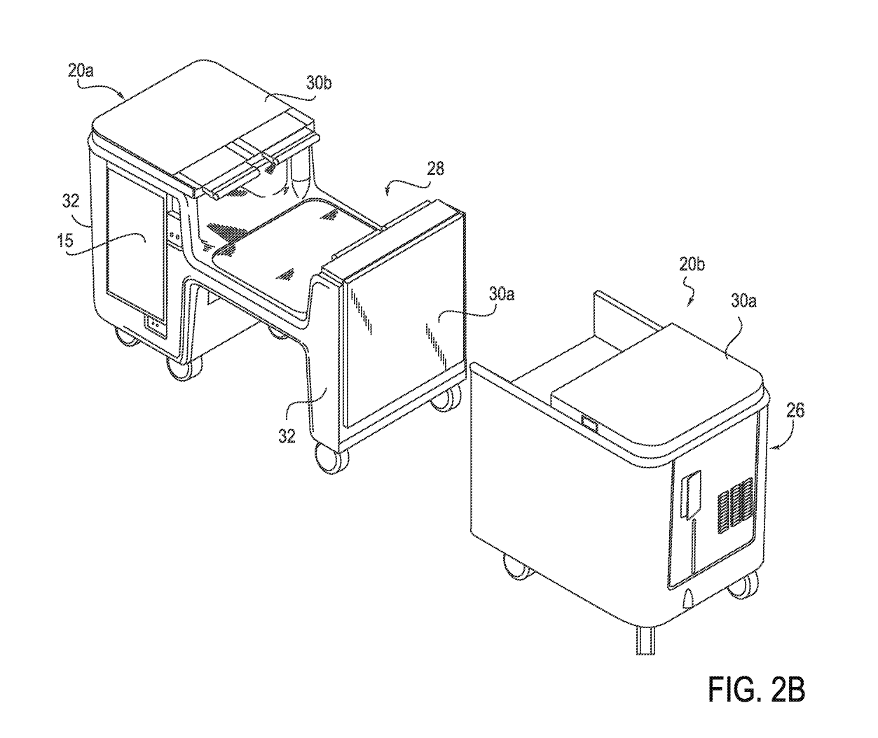

As shown in FIGS. 2A and 2B, a system 10 for performing a medical procedure from below a patient includes two detachable modules including a first or front module 28 and a second or back module 26. In some embodiments, the front module 28 and back module 26 are independently adjustable, serviceable, upgradeable, movable, storable, and/or exchangeable. The front module 28 and back module 26 are sized and configured to be transportable, such that when separated, each module fits through standard-sized hallways and/or doorways. For example, in some embodiments, the width of each module is in the range of 50 cm to 125 cm, or any subrange therebetween. In some embodiments, the width of each module is between 50 to 60 cm, 60 to 70 cm, 70 to 80 cm, 80 to 90 cm, 90 to 100 cm, 100 to 125 cm, or any subrange therebetween. In one embodiment, the width of each module is between 70 cm and 85 cm. In some embodiments, the front module 28 and back module 26 each include a plurality of wheels 21 to facilitate transportation of the modules between various examination rooms and to facilitate movement of the front and back modules 28, 26 relative to each other. In some embodiments, the two detachable modules are hooked, latched, buckled, snapped, or otherwise coupled together to form a first, coupled configuration for clinical procedures. In some embodiments, the two detachable modules are electrically coupled together and connected via electrical connectors.

While a system 10 with a front module 28 and a back module 26 are described herein, in other embodiments, the system may be formed of: a single integrated unit, a right side module and a left side module, or three, four, or more modules.

FIG. 2A illustrates one embodiment of an integrated patient platform with a front module 28 coupled to a back module 26. As shown in FIG. 2A, in the first, coupled configuration, the front module 28 and back module 26 are physically coupled together. In such a configuration, a superior level surface 20a of the front module 28 and a superior level surface 20b of the back module 26 are aligned together and form the patient support surface 20. In some embodiments, the patient support surface 20 is positioned along a horizontal plane on which a patient may be positioned in a supine or prone position. In the coupled configuration, the patient support surface 20 is configured to support a patient lying in a supine or prone position. The patient support surface 20 may be cushioned for improved comfort; alternatively, the patient support surface 20 may be flat and hard, for example, to facilitate disinfection between procedures. In some embodiments, the patient support surface 20 may be contoured and/or include features such as an adjustable leg rest and/or a face cradle to facilitate proper positioning and alignment of a patient's body.

In various embodiments, an aperture (i.e., a gap or hole) 24 extends through the patient support surface 20. The portion of the patient support surface 20 positioned anterior to the aperture is referred to herein as the anterior portion 30b of the patient support surface 20, and the portion of the patient support surface 20 positioned posterior to the aperture 24 is referred to herein as the posterior portion 30a of the patient support surface 20. The aperture 24 may extend the entire width of the patient support surface 20 so as to completely split the anterior portion 30b of the patient support surface 20 from the posterior portion 30a of the patient support surface 20. In other embodiments, the aperture 24 does not extend the entire width of the patient support surface 20. In some such embodiments, the aperture 24 extends at least 50% of the width of the patient support surface 20; in some embodiments, the aperture 24 extends at least 70%, 80%, or 90% of the width of the patient support surface 20. In some embodiments, the aperture 24 is centrally located along the length of the patient support surface 20 such that an anterior portion 30b and a posterior portion 30a of the patient support surface 20 are equal in length. In other embodiments, the aperture 24 is more anteriorly located such that the length of the anterior portion 30b is less than 90%, less than 80%, less than 70%, or less than 60% the length of the posterior portion 30a.

In some embodiments, the top surface 20a of the front module 28 forms the anterior portion 30b of the patient support surface and the top surface 20b of the back module 26 forms the posterior portion 30a of the patient support surface. Alternatively, in other embodiments, such as shown in FIGS. 2A and 2B, the aperture 24 is fully disposed within the top surface 20a of the front module 28, and the top surface 20a of the front module 28 thus includes the anterior portion 30b, the aperture 24, and part of the posterior portion 30a of the patient support surface. In such embodiments, the top surface 20b of the back module 26 forms most of, but not all, the posterior portion 30a of the patient support surface 20.

In some embodiments, in the coupled configuration, the front 28 and back 26 modules are electrically coupled together. In some embodiments, an electrical communication between the front 28 and back 26 modules is established automatically during the process of physically coupling the modules together. For example, each module may include complementary electrical connections such as a plug and socket or other electrical pins and connectors, which enable electrical communications when physically engaged. In some embodiments, electrically coupling the front 28 and back 26 modules together may require manual pairing and/or coupling, for example by physically connecting a cable and plug from one module into an outlet or adaptor in the other module. Additionally or alternatively, once physically coupled, an electrical switch may need to be manually flipped in order to initiate electrical communication between the two modules.

In some embodiments, the front 28 and back 26 modules, when coupled together, perform independent, complementary functions. Alternatively, in some embodiments, the front 28 and back 26 modules are configured to perform some overlapping functions when coupled together.

FIG. 2B illustrates the integrated patient platform of FIG. 2A with the front module 28 decoupled from the back module 26. As shown in FIG. 2B, in the second, decoupled configuration, the front 28 and back 26 modules are separated from one another. The second, decoupled configuration functions to facilitate transportation, repositioning, storage, and/or maneuverability of the integrated patient platform. To facilitate transportation, the front module 28 of some embodiments is foldable into a more portable state. As shown in FIG. 2B, in some embodiments, the screens 15 of the front module 28 fold inward so as to be flush or substantially flush with sidewalls 32 of the front module 28. Additionally or alternatively, in some embodiments, some or all of the posterior portion 30a of the top surface 20a that forms part of the front module 28 folds down so as to rest against a sidewall 32 of the front module 28 and create a more streamlined, portable configuration.

As shown in FIG. 2B, in some embodiments, the back module 26 includes a therapy delivery component 14 and the front module 28 includes an imaging component. Alternatively, in some embodiments, the front module 28 includes a therapy delivery component and the back module 26 includes an imaging component. In other embodiments, both the imaging component and therapy delivery component are stored within the same module (e.g., the front module 28 or the back module 26).

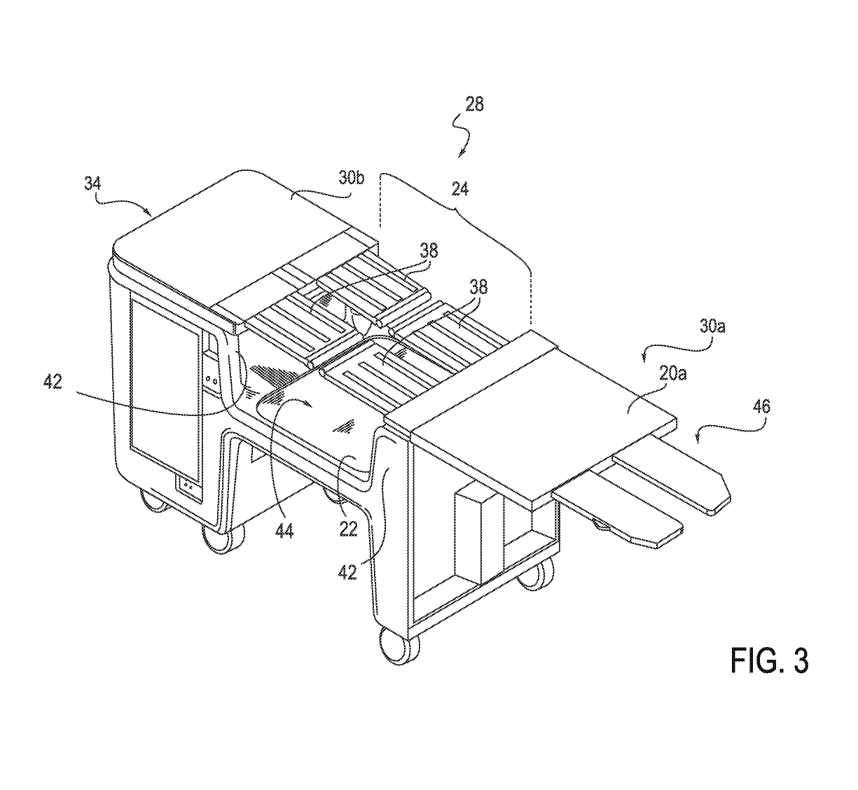

FIG. 3 illustrates one embodiment of a front module 28 of an integrated patient platform. In some embodiments, as shown in FIG. 3, the front module 28 includes: a superior level surface 20a; an aperture 24 disposed within the superior level surface 20a; one or more adjustable shutters 38 movable within the aperture 24 to form an examination window; a workbench or inferior surface 22 disposed at least partially below the examination window; one or more side walls or support beams 42 to support the superior level surface 20a and couple the superior level surface 20a to the workbench 22; and a workspace 44 defined, at least in part, by the one or more movable shutters 38, the side walls or support beams 42, and the workbench 22. In various embodiments, the workspace 44 is sized to fit and enable the operation of a therapy delivery component and/or an imaging component within the workspace. In some embodiments, the front module 28 also includes a connector 46 configured to physically mate with and engage a portion of the back module. For example, as shown in FIG. 3, the front module 28 includes a connector 46 extending from the superior level surface 20a, the connector 46 being configured to slide into and engage receiving portion or socket of a back module.

In some embodiments, one of the modules (e.g., the first/front module) functions as the imaging module. The imaging module includes, couples to, and/or stores an imaging component (described in more detail below). In some embodiments, the imaging module is configured to facilitate positioning of a target region of a patient relative to a medical procedure module for implementation of a medical procedure.

In some embodiments, the aperture (i.e., the gap) 24 between the anterior portion and the posterior portion of the patient support surface is a fixed size; however, at least two movable shutters 38 extend into the aperture 24, enabling adjustment of the effective size of the aperture 24 (i.e., enabling adjustment of an examination window). In various embodiments, the examination window is defined by a leading edge of the at least two movable shutters. The at least two movable shutters 38 are configured to adjust a size and location of the examination window under the patient. In some embodiments, one movable shutter (i.e., an anterior shutter) is coupled to the anterior portion 30b of the patient support surface and a second movable shutter (i.e., a posterior shutter) is coupled to the posterior portion 30a. Alternatively, as shown in FIG. 3, in some embodiments, two or more movable shutters 38 are coupled to the anterior portion 30b and/or two or more movable shutters 38 are coupled to the posterior portion 30a. In some embodiments, the two or more movable shutters 38 lie within the horizontal plane of the patient support surface. In other embodiments, the two or more movable shutters 38 lie along a plane parallel to the horizontal plane of the patient support surface.

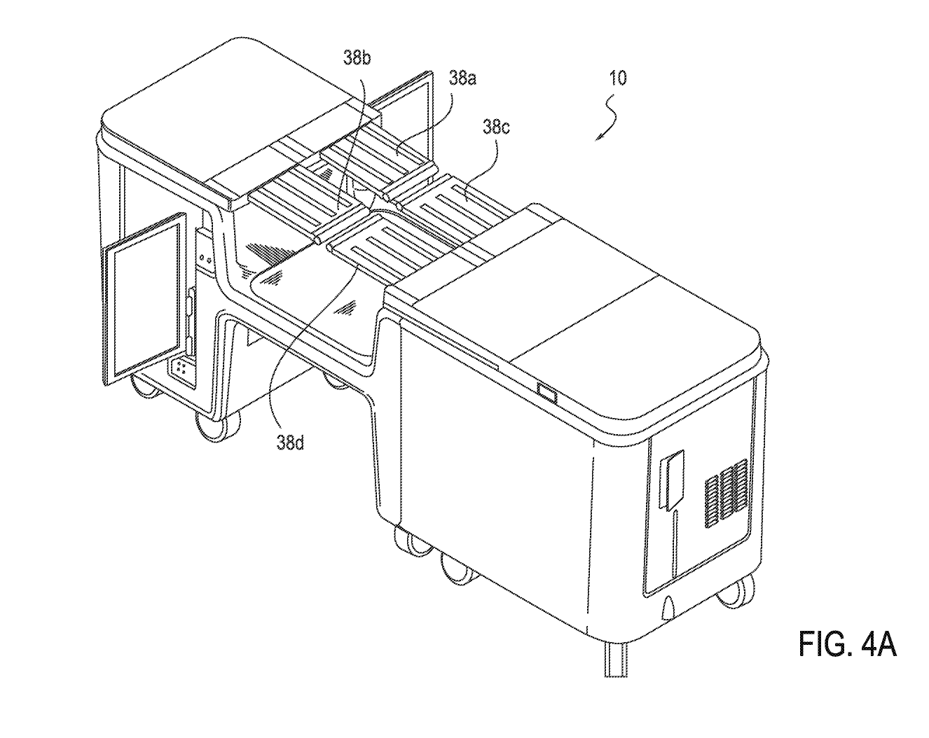

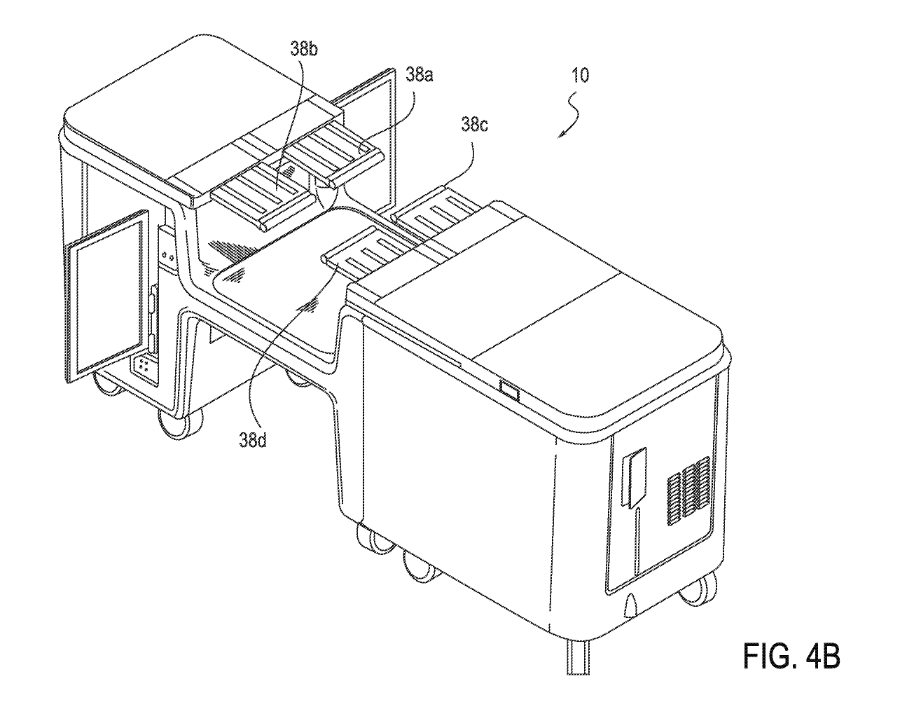

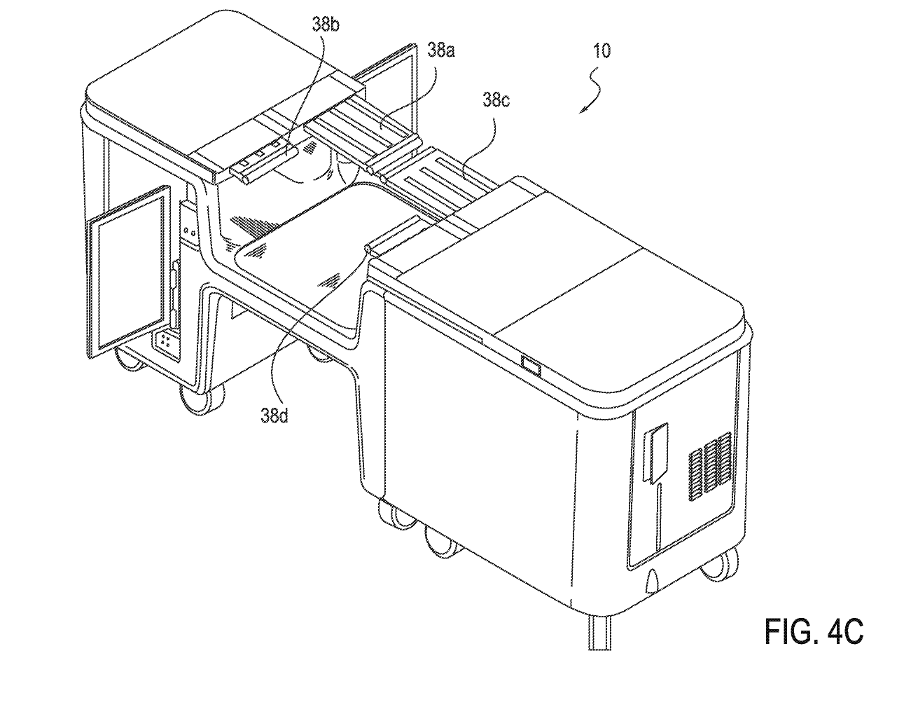

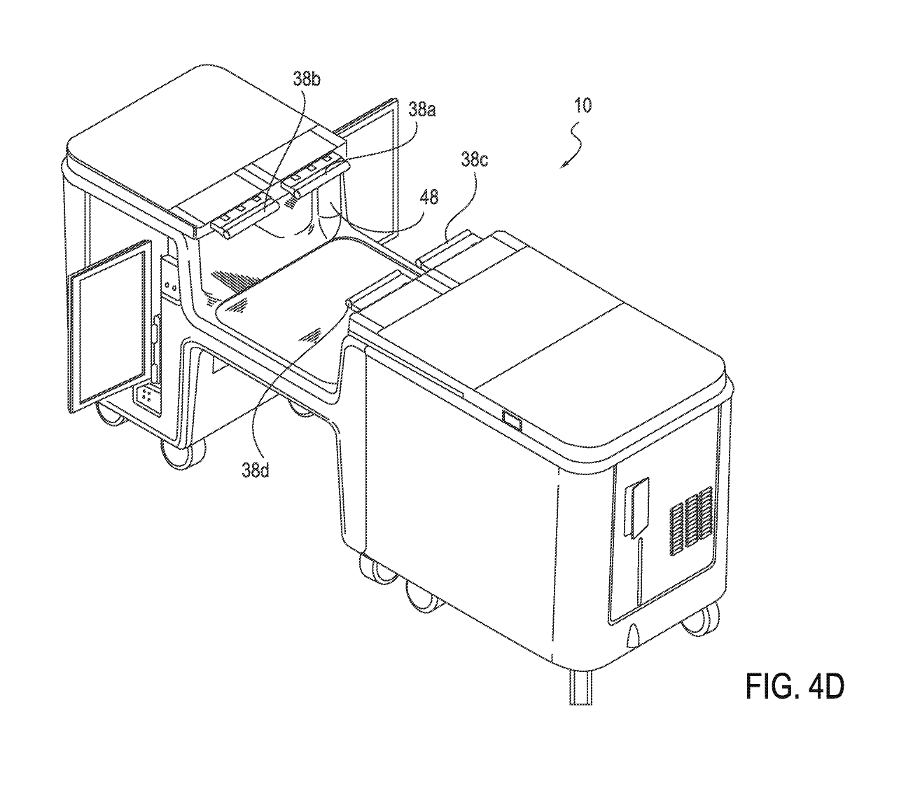

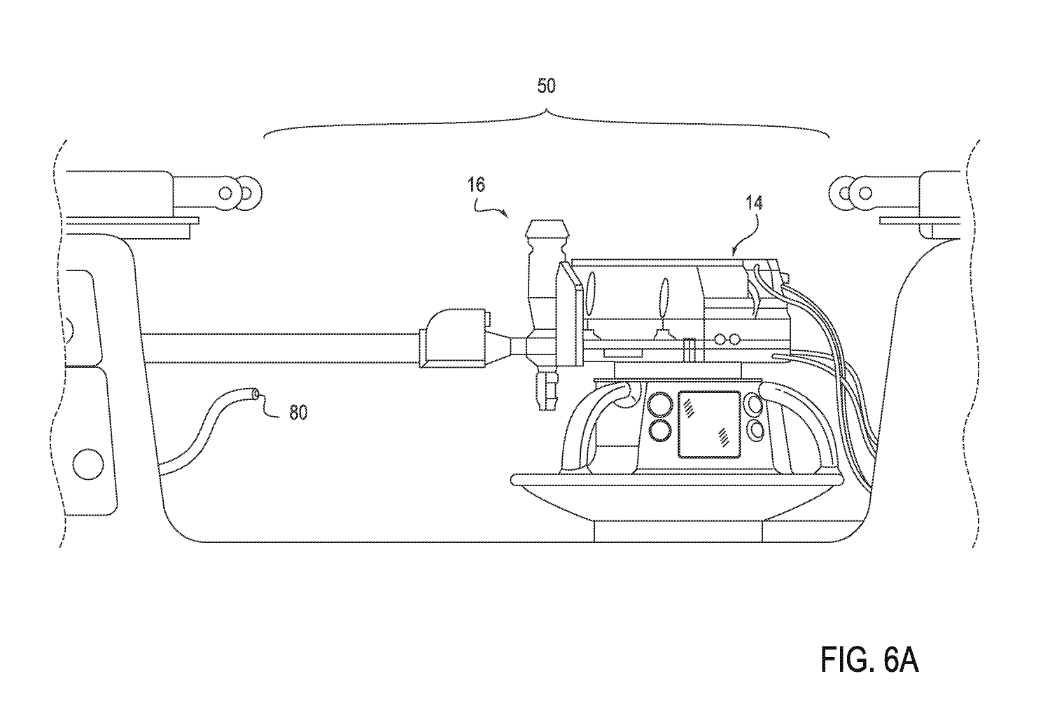

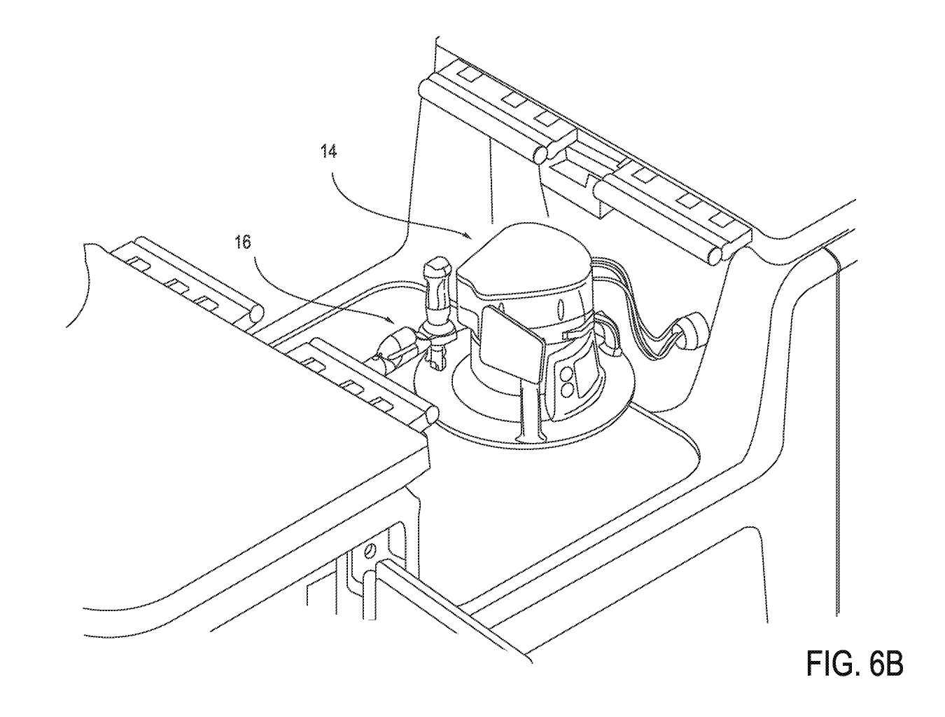

FIGS. 4A-4D illustrate one embodiment of an integrated patient platform 10 having movable shutters 38 shown in various example positions. The movable shutters 38 function to define the examination window 50 in the patient support surface, as labeled in FIG. 6A, and adjust a size and position of the examination window 50. The examination window 50 is configured to provide access to an underside of a patient (e.g., a backside of a patient lying in a supine position or a belly side of a patient lying in a prone position on the patient support surface). The anterior 38a, 38b and posterior 38c, 38d movable shutters may move independently or simultaneously along a plane parallel to the patient support surface to reversibly adjust a size of the examination window 50. For example, the movable shutters 38 may move independently or simultaneously between a fully extended (e.g., FIG. 4A) configuration, a partially retracted (e.g., FIG. 4B) configuration, or a fully retracted (e.g., FIG. 4D) configuration. In some embodiments, in which there are at least four movable shutters, two opposing shutters may be fully extended while two other opposing shutters are fully retracted (e.g., FIG. 4C). Alternatively, two opposing shutters may be fully extended or retracted while two other opposing shutters are partially retracted. Not only the size, but also the position of the examination window 50 may be adjusted, for example, by retracting one shutter while extending an opposing shutter. For example, an examination window of a certain size may be moved posteriorly by retracting a posterior shutter while advancing an anterior shutter. In some embodiments, the two or more shutters 38 are moved sequentially, simultaneously, in opposite directions, and/or in the same direction. In some embodiments, the shutters 38 are configured to move from, and/or return to, a preset position. The preset position may be a closed state in which the examination window 50 is reduced or non-existent and the anterior shutter touches or nearly touches the posterior shutter. Alternatively, the preset position may include an open state sized and positioned to accommodate the target region of an average patient. The preset position may be a factory preset or a preferred, default position set by a clinician or clinical technician.

In some embodiments, the one or more movable shutters 38 are: manually slideable, motorized and slideable, pneumatically actuated, or hydraulically actuated. As shown, in some embodiments, one or more of the movable shutters 38 have a conveyor belt wrapped or looped around the shutter 38. In such embodiments, the conveyor belt fully or substantially covers a surface of the shutter 38 such that a patient's skin interfaces with the conveyor belt surface rather than the shutter surface when the patient is positioned on the patient support platform system 10. The conveyor belt of various embodiments is movably coupled to the shutter 38 such that the conveyor belt rotates as the movable shutter 38 extends or retracts along a plane parallel to the patient support surface 20. Such rotation of the conveyor belt allows the conveyor belt surface (i.e., the patient-interfacing surface) to effectively fall away from the patient's skin during retraction of the shutter and effectively roll up onto the patient's skin during extension of the shutter 38. The configuration of the conveyor belt around the shutter 38 reduces pulling or pinching of a patient's skin during shutter adjustment.

In various embodiments, a three-dimensional workspace exists within the integrated patient platform system and is sized and configured to allow a healthcare professional to work under the patient and position one or more medical procedure components below the patient. As shown in FIGS. 3 and 4C, the top of the three-dimensional workspace 44 is bounded or defined by the patient support surface, the examination window 50, and/or one or more movable shutters 38. The bottom of the workspace is bounded or defined by the workbench (i.e., the inferior surface) 22. Anterior and posterior sides of the workspace 44 are bounded or defined by at least two side struts or side walls 42 of the housing of the front module 28. In various embodiments, access to the workspace 44 is open (i.e., the workspace is unbounded) on a right side and left side of the workspace. The 3-dimensional workspace 44 may be configured to receive a therapy delivery component and/or imaging component. The 3-dimensional workspace 44 functions to provide a space in which therapy and/or imaging components may be positioned, accessed, and manipulated.

In some embodiments, the workspace 44 is a clinically optimized size. For example, in some embodiments, the superior level surface (i.e., the patient support surface) 20 is spaced a clinically optimized distance above the inferior level surface (i.e., the workbench) 22, such that the depth of the workspace is clinically optimized. For example, the depth may be great enough to accommodate an imaging component and/or therapy-delivering component below a patient while also small enough to enable sufficient interfacing between the components and the underside of the patient. In some embodiments, the workbench 22 is positioned 20 to 50 cm below the horizontal plane of the patient support surface 20. In some embodiments, the workbench 22 is 20 to 25 cm, 25 to 30 cm, 30 to 35 cm, 35 to 40 cm, 40 to 45 cm, or 45 to 50 cm below the horizontal plane of the patient support surface 20, or any subrange therebetween. In some embodiments, the workbench 22 is positioned 28 to 32 cm below the horizontal plane of the patient support surface 20. In one embodiment, the workbench 22 is positioned 30 cm below the horizontal plane of the patient support surface 20. In various embodiments, at least a portion of the workbench 22 is positioned below the examination window 50, such that therapeutic and/or imaging ultrasound waves may be angled towards the target region of the patient and delivered without interference. The workbench 22 may be sized and configured to position and manipulate both a therapy delivery component 14 and imaging component 16 on or near the workbench 22 under the examination window 50, as shown in FIGS. 6A-6B.

In some embodiments, the front module 28 further includes a light source 48 configured to illuminate the three-dimensional workspace. For example, the light source 48 may include one or more light emitting diodes, incandescent lights, fluorescent lights, or high-intensity discharge lights. In some embodiments, the light source 48 is disposed within or on one or more of the sidewalls or side pillars of the housing 42. In one embodiment, light emitting diodes 48 are embedded within each of the side pillars 42 of the front module 28. In another embodiment, the light source is movable and slideably disposed in the housing of the front or back module.

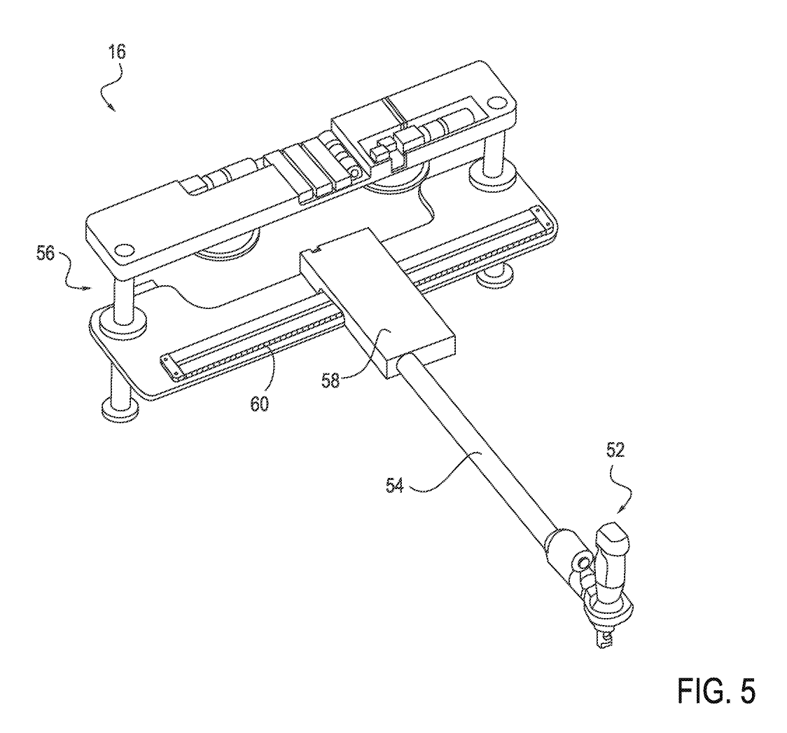

FIG. 5 illustrates one embodiment of an imaging component 16 of an integrated patient platform. In some embodiments, as shown in FIG. 5, the imaging component 16 includes an imager 52 (e.g., an imaging ultrasound transducer), an imaging arm 54, and optionally, an imaging dock 56. The imaging component 16 functions to locate and/or image one or more regions of interest (e.g., a renal artery, kidney, one or more ribs, a space between ribs, etc.) within the patient. In some embodiments, the imaging arm 54 is mounted to the workbench or a sidewall or side pillar of the imaging module. In some embodiments, the imaging component 16 is stored within a housing of the first module in a stored configuration and is movable into the workspace into an operational configuration. In some embodiments, the imaging arm 54 is coupled to an imaging dock 56, which is securely affixed to the workbench 22 or other portion of the imaging module.

In various embodiments, the imaging arm 54 is movable within the workspace 44. As shown in FIG. 5, the imaging component 16 includes a pivotable support or arm 54 (i.e., an imaging arm) and an imager 52 securely or removably coupled to a free, articulating end of the imaging arm 54. The imaging component 16 is configured to allow movement of the imaging arm 54 (and resultant positioning of the imager) in the workspace between the workbench and the examination window. In some embodiments, the imaging component 16 is manipulatable in one degree-of-freedom (DOF), two DOFs, three DOFs, four DOFs, five DOFs, or six DOFs. In one embodiment, the imaging component 16 is manipulatable in six DOFs (i.e., left/right, up/down, forward/backward, pitch, yaw, and roll). In one embodiment, the imaging arm 54 is manipulatable in three DOFs (i.e., left/right, up/down, and forward/backward) and the imager 52 is pivotable relative to the imaging arm 54 in three DOFs (i.e., pitch, yaw, and roll). In some embodiments: the imager 52 is pivotable in three DOFs (i.e., pitch, yaw, and roll); the imaging arm 54 is telescopically, pneumatically, or otherwise extendable and retractable from an extension base 58; the extension base 58 is slidable along a track or rail 60 for left/right movement along the imaging dock, and the track or rail 60 is configured to be raised and lowered for up/down movement along the imaging dock 56. In some embodiments, the imaging component 16 is manually movable, for example, by manually pulling on, pushing, or twisting the imaging component 16 or imager 52. In other embodiments, movement of the imaging component 16 is motorized and controlled via a computerized controller.

In some embodiments, the imaging arm 54 includes one or more locking mechanisms to lock the imaging arm 54 and/or imager 52 in a fixed position. The locking mechanisms may be any suitable locking mechanism known in the art and may be actuated via any suitable, known actuation feature, including, for example, one or more knobs, push buttons, latches, and/or slide buttons. In some embodiments, pressing or manipulating a single button or other actuation feature may restrict movement in every degree of freedom. For example, in one embodiment, the imaging component 16 may be configured such that pressing a single button locks the imaging component 16 in place along all six degrees of freedom. In various embodiments, the imaging component 16 is reversibly lockable and configured to return to a movable state upon manipulating an actuation feature. Further, in some embodiments, the imaging component 16 is counterbalanced and/or spring-loaded upwardly toward the examination window such that the imaging arm 54, when positioned below a patient, is drawn upward to exert pressure onto the patient's body. In some embodiments, the imaging arm 54 is spring-loaded with 1 to 12 lbs. of force or any subrange or value therebetween. In one embodiment, the imaging arm 54 is spring-loaded with approximately 6 lbs. of force.

In some embodiments, the integrated patient platform system includes a patient-positioning camera 80. The patient-positioning camera 80 may be mounted or mountable to the workbench 22 or a sidewall or side pillar 42 of the front or back module. In some embodiments, the patient-positioning camera 80 is stored within a housing of the front or back module in a stored configuration and is movable into the workspace into an operational configuration. In various embodiments, the patient-positioning camera 80 is pointed upward toward the examination window 50 to capture an image of any objects or body portions positioned in or over the examination window. The patient-positioning camera functions to determine a position of the patient or target region of the patient relative to the workspace, workbench, examination window, therapy delivery component, and/or imaging component. The patient-positioning camera enables a healthcare provider to confirm that a patient is properly aligned on the patient support surface without needing to walk around the integrated patient platform to view the patient's position from multiple angles. The patient-positioning camera includes a camera and a mount, arm, or lever. In some embodiments, the patient-positioning camera is disposed within the workspace, for example, so that the camera may view and/or image the portion of the patient positioned in or over the examination window.

Further, one of the modules, for example, the imaging or front module, may include one more display screens 15 coupled thereto, as shown in FIGS. 1A-1C. The one or more display screens 15 function to display one or more images (e.g., color Doppler, B-mode, color power Doppler, directional color power Doppler mode, etc.) of the target area acquired by the imager of the imaging component, one or more user interface elements (e.g., buttons, sliders, radio buttons, drop down menus, data entry fields, etc.) to control and/or alter a function of one or more system components (e.g., an imaging component, therapy delivery component, optical tracking camera, or patient-positioning camera), and/or one or more instructions for operating one or more system components. In some embodiments, the imaging or front module includes a user interface configured to receive user inputs, for example to control the motion of one or more movable shutters. In some embodiments, the user interface includes a graphical user interface and a user input device (e.g., one or more keys, one or more buttons, a mouse, a keyboard, a toggle, a switch, a joystick, and/or a touchscreen).

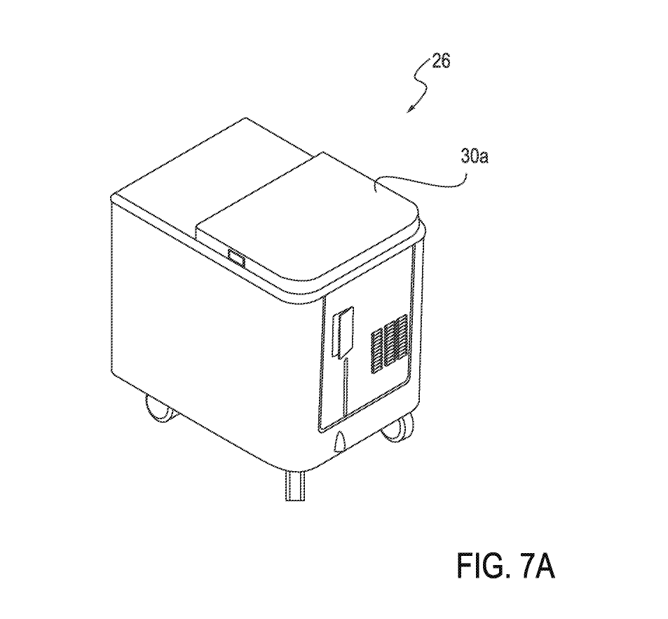

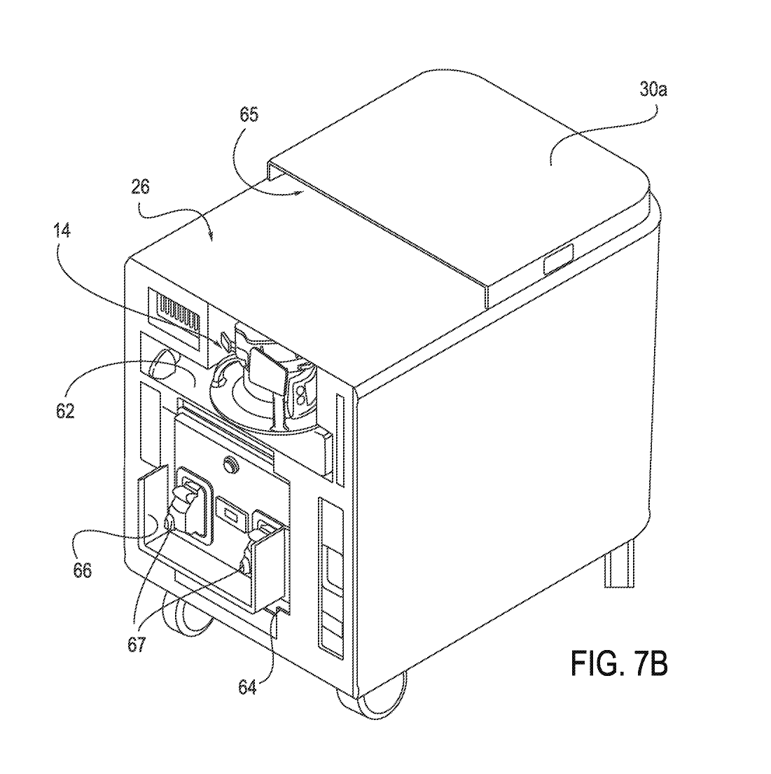

FIGS. 7A-7B illustrate various views of one embodiment of a second or back module 26 of an integrated patient platform. In some embodiments, the second module includes a portion of a patient support surface 20, for example, all or a majority of a posterior portion 30a of the patient support surface. In some embodiments, the patient support surface of the second module 26 includes an adjustable leg support positioned on the posterior surface of the patient support surface. The adjustable leg support functions to bend and elevate or raise a patient's legs, so that the lower back of the patient lies in a more flat or planar configuration in the examination window. The adjustable leg support may be an arcuate, beveled, or otherwise curved surface. The adjustable leg support may be slideable along the patient support surface. The adjustable leg support may be a cushion positioned on a hard surface.

In some embodiments, as shown in FIGS. 7A and 7B, the back module 26 (i.e., the second module) is a treatment module, which is configured to store or house a therapy delivery component, such as the therapy delivery component described in pending PCT U.S. application Ser. No. 14/22141, filed Mar. 7, 2014 and entitled: “Transducers, Systems, and Manufacturing Techniques for Focused Ultrasound Therapies,” which is herein incorporated by reference in its entirety.

As shown in FIG. 7B, the back module 26 includes one or more cavities, pockets, chambers, recesses, interior levels, or shelves 62 in a housing 64 for storing a therapy delivery component 14 (e.g., during nonuse of the treatment component), a cable management system, and/or other system components (e.g., a water conditioner, generator, power supply, etc.). In some embodiments, the housing 64 of the back module 26 includes one or more sidewalls 66 oriented perpendicularly or substantially perpendicularly to the patient support surface and which are positioned between the patient support surface and the floor. In some embodiments, an interior level or shelf of the integrated patient platform is disposed within housing 64 sidewalls 66 of the back module 26. In some embodiments, the interior level is configured to support a therapy delivery component and is positioned along the same horizontal plane as the workbench. In some embodiments, a sidewall 66 of the housing 64 of the treatment module 26, adjacent to the workspace, includes an aperture sized and configured to allow the treatment component to move horizontally between a stored configuration inside the housing 64 of the treatment module 26 and an operational or functional configuration on the workbench and in the workspace. In some embodiments, movement or sliding of the treatment component is facilitated by one or more rails, wheels, or gliders or vacuum suction. In some embodiments, movement of the treatment component is facilitated by a cable management system, as described in more detail below. In some embodiments, when the back module 26 is coupled to the front module, the one or more shelves (e.g., the inferior level surface) of the back module 26 in the housing 64 may form a substantially continuous surface with the workbench of the front module, so that the therapy delivery component may readily glide or move from the stored configuration in the housing 64 to the operational or functional configuration on the workbench in the workspace. In some embodiments, an interior of the housing 64 is further accessible from one or more sides of the back module 26, for example through a housing door (e.g., one or more cabinet doors) coupled to the back module by one or more hinges or tracks for sliding. In some embodiments, the interior level is positioned within the housing behind the housing door, for example, for secure storage and support of the clinical procedure module during transport. In some embodiments, the back module 26 includes one or more coupling features to physically and/or electrically couple the back module to the front module. For example, as shown in FIG. 7B, in some embodiments, the back module 26 includes a receiving portion or socket 65 for receiving a physical connector of the front module and/or one or more electrical plugs or sockets 67 for establishing an electrical connection with one or more plugs or sockets of the front module.

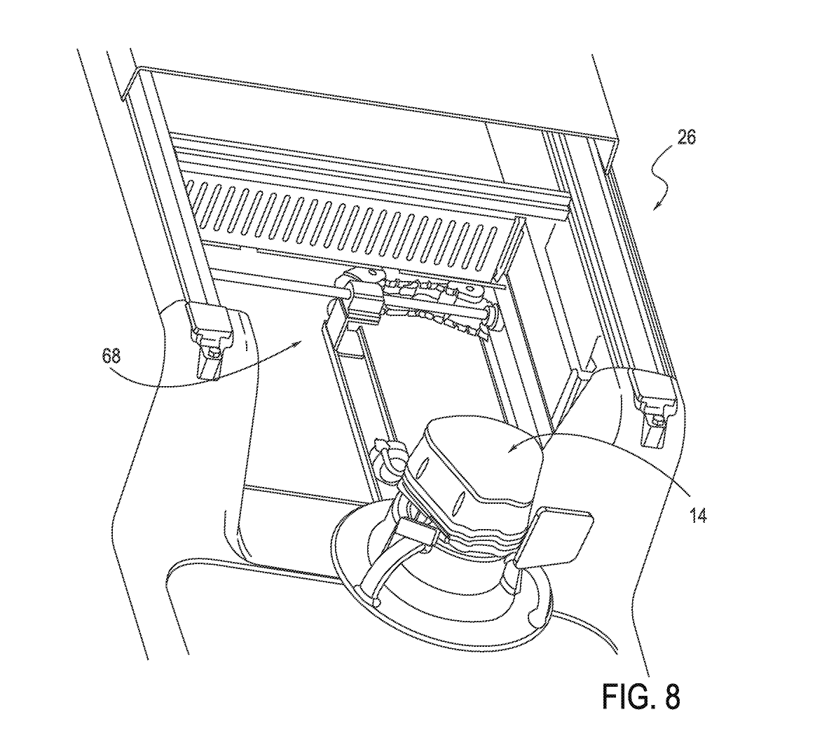

FIG. 8 illustrates one embodiment of a cable management system 68. In some embodiments, the second or back module includes a cable management system 68 within the housing, as shown in FIG. 8. In some embodiments, the cable management system 68 is configured to facilitate unobstructed movement of the therapy delivery component 14 from the stored position to the functional position. Further, in some embodiments, the cable management system 68 functions to lift one or more cables leading to one or more system components (e.g., a therapy delivery component, water conditioner, power supply, generator, front module, imaging component, etc.) and to reduce friction between the one or more cables and the inferior level or other structures of the housing of the second module 26. For example, in some embodiments, the cable management system 68 uses a series of rails mounted on a series of bearings to enable horizontal and/or lateral movements of the one or more cables (i.e., movements of the cables along an x-axis and/or y-axis), so that the cables can extend and bend in the air with minimal contact with the housing of the second or back module 26.

In some embodiments, the back module 26 further functions to store the patient-positioning camera 80. For example, the arm or lever of the patient-positioning camera may be retracted into the housing of the back module to position the patient-positioning camera in a stored configuration and extended out of the housing into the workspace to position the patient-positioning camera in a functional or operational configuration.

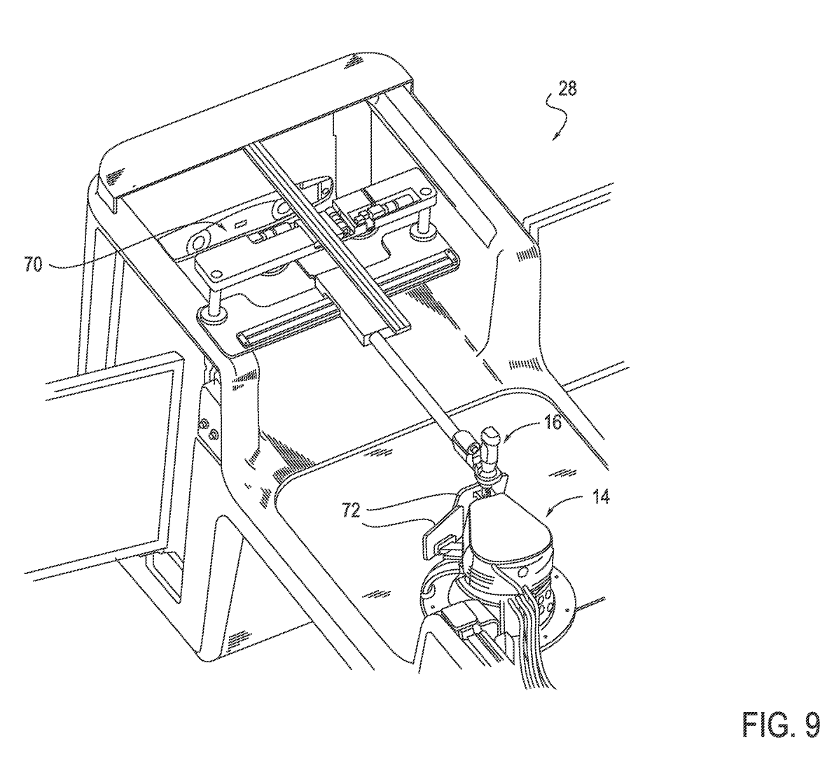

FIG. 9 illustrates one embodiment of an optical tracking system for tracking a position, location, and/or orientation of one or more system components. The optical tracking system is shown positioned on the workbench and within the housing of the front, imaging module 28. In some embodiments, the optical tracking system includes an optical tracking camera 70, one or more optical sensors or encoders 72 positioned on the imaging component 16, and/or one or more optical sensors or encoders 72 positioned on the therapy delivery component 14. In some embodiments, the one or more optical sensors 72 are permanently affixed or temporarily secured to the imaging component 16 and therapy delivery component 14, enabling tracking of a position, location, and/or orientation of the imaging component 16 and/or therapy delivery component 14 within a defined coordinate system in the workspace and/or relative to each other. The position, location, and/or orientation of the components may also be tracked relative to an examination window, a patient, a target region of the patient, a workbench, and/or any other structure. In some embodiments, the one or more optical sensors 72 are tracked by an optical tracking camera 70 positioned within the front module or back module, as shown in FIG. 9. In some embodiments, the optical sensors 72 are active infrared-emitting markers, which emit a focused infrared light that the optical tracking camera 70 receives and tracks. In some embodiments, the optical sensors 72 are passive retro-reflective markers, which reflect an infrared light back to the optical tracking camera 70, for receiving and tracking by the optical tracking camera 70; in such embodiments, the reflected infrared light is generated by an illuminator on the optical tracking camera 70. Based on the strength, direction, and angle of the received infrared lights, a computer that forms a portion of the optical tracking camera 70 is able to calculate the position and orientation of each component within the workspace.

In various embodiments, the optical tracking system enables concurrent imaging of a patient and targeted therapy delivery, wherein the therapy delivery is targeted based on the images received from the imager of the imaging component 16. For example, in some embodiments, the imager is an ultrasound transducer capable of delivering ultrasonic waves into a portion of a patient's body to image the internal structures within said portion of the body. In some such embodiments, the therapy delivery component 14 is configured to deliver focused, high energy therapeutic ultrasonic waves to a targeted region of the patient's body. By having two separate ultrasonic transducers and a system for tracking the orientation and position of each transducer relative to the other, the system enables a clinician to identify and track the targeted region of the patient's body while providing uninterrupted delivery of therapeutic energy to the targeted region.

The front module 28, back module 26, and workspace 44 are sized such that the optical tracking camera 70 is positioned an optimized distance away from each of the therapy delivery component 14 and the imaging component 16 when the therapy delivery component 14 and the imaging component 16 are in a functional position on the workbench surface. For example, in some embodiments, the optical tracking camera 70 is positioned 40-160 cm away from each of the therapy delivery component 14 and the imaging component 16 when the therapy delivery component 14 and the imaging component 16 are in the functional or operational position. In some embodiments, the optical tracking camera 70 is positioned 40 to 140 cm away from each of the therapy delivery component 16 and the imaging component 14, or any subrange therebetween. In some embodiments, the optical tracking camera 70 is positioned 40 to 50 cm, 50 to 60 cm, 60 to 70 cm, 70 to 80 cm, 80 to 90 cm, 90 to 100 cm, 100 to 110 cm, 110 to 120 cm, 120 to 130 cm, or 130 to 140 cm away from each of the therapy delivery component 16 and the imaging component 14.

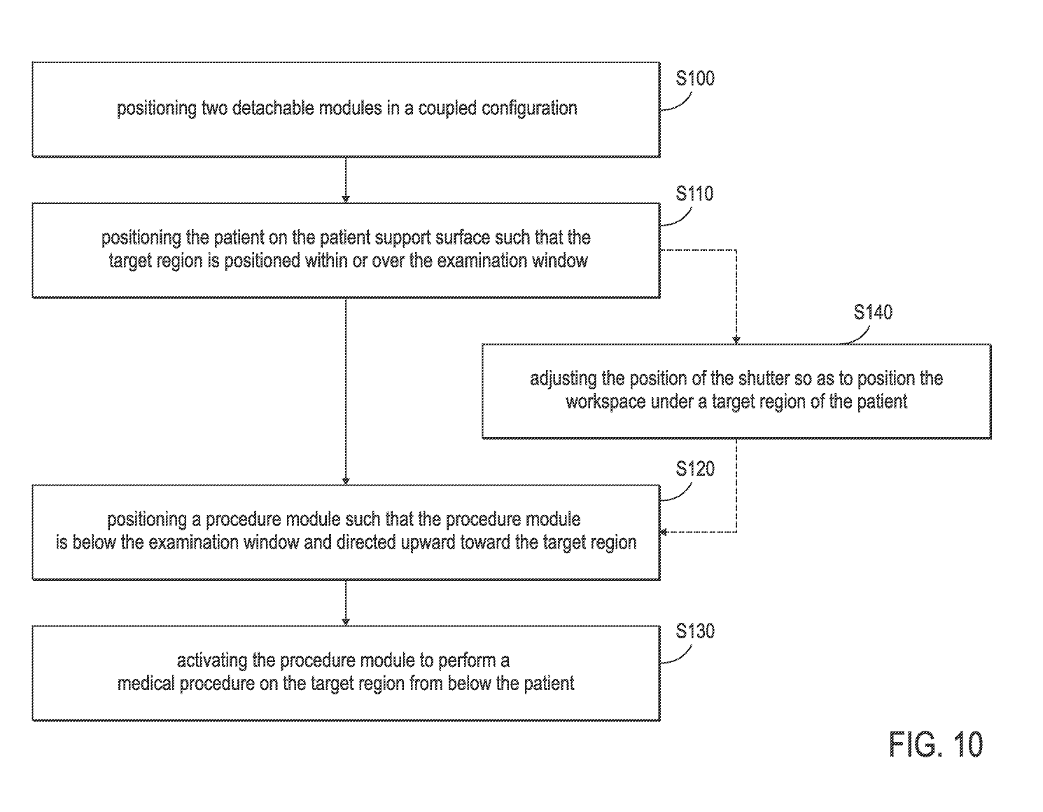

FIG. 10 illustrates a flow chart of one embodiment of a method of performing a medical procedure on a patient lying on the patient support surface of an integrated patient platform system. As shown in FIG. 10, a method of performing a medical procedure on a patient lying on a patient support surface of one embodiment includes positioning two detachable modules in a coupled configuration S100, positioning the patient on the patient support surface such that a target region of the patient is positioned within or over an examination window disposed within the patient support surface S110, positioning a procedure module such that the procedure module is below the examination window and directed upward toward the target region S120, and activating the procedure module to perform a medical procedure on the target region from below the patient S130. The method may further include adjusting the position of a shutter within an aperture of the patient support surface so as to position the examination window and workspace under a target region of the patient S140. The method functions to position a patient on a transportable and/or maneuverable patient support surface to facilitate to the performance of a procedure on a target region of a patient. The method of some embodiments is used in the therapeutic ultrasound field and/or renal denervation field, but can additionally or alternatively be used for ultrasonic imaging or any other suitable applications, clinical or otherwise.

As shown in FIG. 10, a method of performing a medical procedure on a patient lying on a patient support surface includes S100, which recites positioning two detachable modules in a coupled configuration. S100 functions to electrically couple a front module with a back module (or an imaging module with a therapy module) to prepare for a medical procedure. The two modules, for example a therapy module and an imaging module, may be stored in a decoupled or detached configuration, independently maneuvered or transported to the medical procedure site, and physically and/or electrically coupled to form a patient support surface having an examination window. In some embodiments, one or both of the front module and the back module include a computing device, and both modules include electrical wiring. When coupled together, the modules function electrically as one unit with each of the front module, back module, therapy delivery component, imaging component, patient-positioning camera, and optical tracking system electrically coupled together. In various embodiments, when coupled together, a touchscreen or other input device functions to receive inputs from a user, and based on the user inputs, the one or more computing devices drive performance of the adjustable shutters, therapy delivery component, imaging component, patient-positioning camera, and/or optical tracking system.

As shown in FIG. 10, a method of performing a medical procedure on a patient lying on a patient support surface includes S110, which recites positioning the patient on the patient support surface such that the target region is positioned within or over the examination window. In some embodiments, the patient is positioned in a supine position, so that a region of the back is positioned within or over the examination window. Alternatively, the patient is positioned in a prone position, so that a region of the stomach is positioned within or over the examination window.

In some embodiments, as shown in FIG. 10, the method further includes S140, which recites adjusting a position of one or more shutters so as to position the examination window and workspace under a target region of the patient. In some embodiments, the examination window is formed by one or more shutters extending into an aperture disposed within the patient support surface. In some embodiments, the one or more shutters are movable, for example, at least between an open configuration (e.g., all movable shutters are in a fully retracted state), a partially open configuration (e.g., one or more movable shutters are partially retracted), or a closed configuration (e.g., all movable shutters are fully extended, such that a leading edge of one shutter touches or nearly touches a leading edge of another shutter). The one or more shutters may be movable together or independently and opposing shutters may be movable in a same direction or opposite directions so as to adjust the size and/or the position of the examination window. The one or more movable shutters may be manually or electronically actuated, for example, upon receiving a user input or detecting a target region of the patient. The target region may be detected by the therapy delivery component, imaging component, patient-positioning camera, optical tracking system, and/or any other procedure module. In some embodiments, adjusting a position of one or more shutters involves mechanically sliding a shutter along a horizontal plane to extend or retract it, while a conveyor belt wrapped around the shutter rotates relative to a surface of the shutter.

As shown in FIG. 10, a method of performing a medical procedure on a patient lying on a patient support surface includes S120, which recites positioning a procedure module such that the procedure module is below the examination window and directed upward toward the target region. S120 functions to prepare the workbench or workspace for a medical procedure. In some embodiments, a procedure module includes a therapy delivery component, an imaging component, an optical tracking camera, and/or a patient-positioning camera. The procedure module is moved or repositioned from a stored configuration in a housing of the front or back module to an operational or functional configuration in the workspace and/or on the workbench.

As shown in FIG. 10, a method of performing a medical procedure on a patient lying on a patient support surface includes S130, which recites activating the procedure module to perform a medical procedure on the target region from below the patient. S130 functions to prepare the procedure module for performing one or more medical procedures. In the operational configuration, the procedure module may be activated and manipulated, for example, to direct ultrasonic waves of an imaging and/or therapeutic frequency upwards through the examination window and towards a target region of a patient. In some embodiments, activating a procedure module includes activating or actuating a user input mechanism (e.g., a button, switch, slider, icon, etc.) on the procedure module or an electrically connected user input device to turn on the procedure module. In some embodiments, activating a procedure module includes inputting one or more instructions directly into the procedure module. In some embodiments, activating a procedure module includes inputting one or more instructions into a computer of the front or back module, for example, via a keyboard or touchscreen. In such embodiments, the computer of the front or back module is electrically and communicatively coupled to the procedure module.

In some embodiments, all or substantially all functionality of the system can be controlled by a central user input device, such as a touchscreen. From the touchscreen, a user may be able to: control movements of the shutters to adjust the size and position of the aperture, activate an imaging component, observe the image generated by the imaging component, manipulate the position of the imaging component to locate a target region in a patient, direct a therapy delivery component to adjust its position so that it shares the same target as the imaging component, activate the therapy delivery component, and control the duration and intensity of the therapy delivered by the therapy delivery component.

The systems and methods of the preferred embodiments and variations thereof can be embodied and/or implemented, at least in part, by or on a machine with a computer-readable medium storing computer-readable instructions. The instructions are preferably executed by computer-executable components preferably integrated with the system. The computer-readable medium can be stored on any suitable computer-readable media such as RAMs, ROMs, flash memory, EEPROMs, optical devices (e.g., CD or DVD), disk drive, solid state drive, or other hard drives, floppy drives, or any suitable device. The computer-executable component is preferably a general or application-specific processor, but any suitable dedicated hardware or hardware/firmware combination can alternatively or additionally execute the instructions. For example, in various embodiments, one or more of the front module, back module, therapy delivery component, imaging component, optical tracking camera, and/or patient-positioning camera are specialized computerized systems containing a processor for executing specialized instructions for operation and memory for storing said specialized instructions. The computerized systems are controllable, at least in part, via user or system inputs.

As used in the description and claims, the singular form “a”, “an” and “the” include both singular and plural references unless the context clearly dictates otherwise. For example, the term “an anterior shutter” may include, and is contemplated to include, a plurality of anterior shutters. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or width), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method comprising essentially of the elements as defined herein would not exclude other materials, features, or steps that do not materially affect the basic and novel characteristic(s) of the claimed invention. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Thus, although specific embodiments have been illustrated and described herein, any arrangement calculated to achieve the same purpose may be substituted for the specific embodiments shown. This disclosure is intended to cover any and all adaptations or variations of various embodiments, and it will be readily apparent to those of ordinary skill in the art, in light of the teachings of these embodiments, that numerous changes and modifications may be made without departing from the spirit or scope of the appended claims.

What is claimed is:

1. An integrated patient platform configured to support a patient thereon during a medical procedure, the integrated patient platform comprising:
two detachable modules, the two detachable modules comprising a front module and a back module, wherein:
the front and back modules are each independently movable,
the front and back modules are positionable in a first, coupled configuration for clinical procedures and positionable in a second, separated configuration for transportation, and
in the first, coupled configuration, the front and back modules are in electrical communication and attached such that a top surface of the front module and a top surface of the back module together form a patient support surface, wherein an examination window is disposed within the patient support surface and sized to accommodate a target region of a patient on which a medical procedure is to be performed from below.

2. The integrated patient platform of claim 1, wherein the examination window is a clinically optimized size.

3. The integrated patient platform of claim 1, wherein the front module comprises a therapy delivery component and the back module comprises an imaging component.

4. The integrated patient platform of claim 1, wherein the back module comprises a therapy delivery component and the front module comprises an imaging component.

5. The integrated patient platform of claim 4, wherein the back module comprises a housing configured to store the therapy delivery component, and wherein a sidewall of the housing includes an aperture sized to enable horizontal movement of the therapy delivery component from a stored position within the housing to a functional position outside the housing.

6. The integrated patient platform of claim 5, further comprising a cable management system within the housing, the cable management system configured to facilitate unobstructed movement of the therapy delivery component from the stored position to the functional position.

7. The integrated patient platform of claim 4, wherein the examination window is disposed within the top surface of the front module, and wherein the front module further comprises a workbench surface positioned at a clinically optimized distance below the examination window.

8. The integrated patient platform of claim 7, wherein the imaging component comprises an imager and an imaging arm, the imaging arm being coupled to the front module and moveable within a workspace between the workbench surface and the examination window.

9. The integrated patient platform of claim 8, further comprising an optical tracking camera mounted within the front module or back module, the optical tracking camera configured to wirelessly communicate with an optical sensor in the imager and an optical sensor in the therapy delivery component.

10. The integrated patient platform of claim 9, wherein the front module or back module is sized such that the optical tracking camera is positioned an optimized distance away from each of the therapy delivery component and the imager when the therapy delivery component and the imager are in a functional position on the workbench surface.

11. The integrated patient platform of claim 10, wherein the optical tracking camera is positioned 40-160 cm away from each of the therapy delivery component and the imager when the therapy delivery component and the imager are in the functional position.

12. The integrated patient platform of claim 1, wherein the front module and back module perform complementary functions and are configured to coordinate the complementary functions When in electrical communication.

13. The integrated patient platform of claim 1, Wherein the front module and the back module perform independent functions.

14. The integrated patient platform of claim 1, Wherein the front module and back module are independently adjustable, serviceable, upgradeable, or exchangeable.

15. The integrated patient platform of claim 1, wherein the electrical communication between the front and back modules is established automatically in the first, coupled configuration.

16. An integrated patient platform comprising:
a superior level surface; and
an inferior level surface,
wherein the superior level surface is configured to support a patient and includes at least two movable shutters configured to adjust a size and location of an aperture under the patient, the aperture disposed within the superior level surface,
wherein the inferior level is located below the aperture and forms a work bench configured to support a clinical procedure module, and
wherein the superior level is spaced a clinically optimized distance above the inferior level surface.

17. The integrated patient platform of claim 16, wherein the clinically optimized distance is 20-50 cm.

18. The integrated patient platform of claim 16, wherein the clinically optimized distance is 30 cm.

19. The integrated patient platform of claim 16, wherein the clinical procedure module that the work bench is configured to support is selected from one or more of: a therapy delivery component, an imaging component, an optical tracking camera, and an optical sensor,

20. The integrated patient platform of claim 16, wherein the at least two movable shutters are independently adjustable.

21. The integrated patient platform of claim 16, further comprising an interior level positioned below the superior level and disposed on a shared horizontal plane with the inferior level.

22. The integrated patient platform of claim 21, wherein the interior level is positioned within a housing behind a housing door and is configured to support the clinical procedure module during transport.

23. An integrated patient platform comprising:
a patient support surface positioned along a horizontal plane and comprising an anterior portion and a posterior portion, wherein the anterior and posterior portions are spaced a fixed distance from each other and together define an examination window therebetween;
an anterior shutter coupled to the anterior portion;
an anterior conveyor belt forming a loop around the anterior shutter;
a posterior shutter coupled to the posterior portion; and
a posterior conveyor belt forming a loop around the posterior shutter;
wherein the anterior and posterior shutters are each movable along a plane parallel to the patient support surface and are configured to extend into the examination window.

24. The integrated patient platform of claim 23, wherein the anterior shutter and posterior shutter are independently adjustable,

25. The integrated patient platform of claim 23, wherein the integrated patient platform comprises two or more anterior shutters.

26. The integrated patient platform of claim 23, wherein the integrated patient platform comprises two or more posterior shutters.

27. The integrated patient platform of claim 23, wherein the anterior conveyor belt is movably coupled to the anterior shutter such that, the belt rotates when the anterior shutter moves along the plane.

28. The integrated patient platform of claim 23, wherein the posterior conveyor belt is movably coupled to the posterior shutter such that the belt rotates when the posterior shutter moves along the plane,

29. The integrated patient platform of claim 23, wherein the patient support surface is sized to accommodate a patient laying in a supine or prone position.

30. The integrated patient platform of claim 23, further comprising an adjustable leg support positioned on the posterior surface of the patient support surface.

31. The integrated patient platform of claim 23, wherein the anterior and posterior shutters are: manually slideable, motorized and slideable, pneumatically actuated, or hydraulically actuated.

32. The integrated patient platform of claim 23, further comprising a user interface configured to receive user inputs, wherein user inputs control the motion of the anterior and posterior shutters.

33. The integrated patient platform of claim 32, wherein the user interface comprises a graphical user interface and a user input device.

34. The integrated patient platform of claim 33, wherein the user input device is selected from a group consisting of: one or more keys, one or more buttons, a mouse, a keyboard, a. toggle, a switch, a joystick, and a touchscreen.

35. An integrated patient platform comprising:
a patient support surface positioned along a horizontal plane and comprising an anterior portion and a posterior portion, wherein the anterior and posterior portions are spaced a fixed distance from each other and together define an examination window therebetween;
a shutter slidable along a plane parallel to the patient support surface and configured to adjust a size of the examination window;
a workbench surface disposed below the examination window along a plane parallel to the horizontal plane of the patient support surface; and
a housing below the anterior portion or the posterior portion of the patient support platform, wherein the housing defines a storage space configured to store a procedure module in a stored position, and wherein the housing includes an aperture sized to enable horizontal movement of a procedure module from the stored position within the housing to a functional position on the workbench surface.

36. The integrated patient platform of claim 35, further comprising the procedure module.

37. The integrated patient platform of claim 36, wherein the procedure module is an imaging component.

38. The integrated patient platform of claim 36, wherein the procedure module is a therapy delivery component.

39. The integrated patient platform of claim 35, further comprising a patient-positioning camera supported by the workbench surface and pointed upward toward the examination window.

40. The integrated patient platform of claim 35, further comprising a cable management system within the housing, the cable management system configured to facilitate unobstructed movement of the procedure module from the stored position to the functional position.

41. The integrated patient platform of claim 35, wherein the integrated patient platform comprises an anterior shutter coupled to the anterior portion and a posterior shutter coupled to the posterior portion.

42. An integrated patient platform comprising:
a patient support surface positioned along a horizontal plane and comprising an anterior portion and a posterior portion, wherein the anterior and posterior portions are spaced a fixed distance from each other and together define an examination window therebetween;
a shutter slidable along a plane parallel to the patient support surface and configured to adjust a size of the examination window; and
a workbench surface disposed below the examination window along a plane parallel to the horizontal plane of the patient support surface, wherein the workbench surface is positioned 20-50 cm below the horizontal plane of the patient support surface.

43. The integrated patient platform of claim 42, wherein the workbench surface is positioned 30 cm below the horizontal plane of the patient support surface.

44. The integrated patient platform of claim 42, wherein the integrated patient platform comprises an anterior shutter coupled to the anterior portion and a posterior shutter coupled to the posterior portion.

45. The integrated patient platform of claim 42, further comprising a housing disposed below the patient support surface, wherein the housing is coupled to and supports the patient support surface.

46. The integrated patient platform of claim 45, wherein the workbench surface and an edge of the shutter together define an open workspace.

47. The integrated patient platform of claim 46, wherein the open workspace is further defined by sidewalls or side pillars of the housing.

48. The integrated patient platform of claim 47, further comprising a light source configured to illuminate the open workspace.

49. The integrated patient platform of claim 48, wherein the light source comprises one or more light emitting diodes disposed within one or more of the sidewalk or side pillars of the housing.

50. An integrated patient platform comprising:
a patient support surface configured to support a patient during a medical procedure, the patient support surface having an aperture disposed therein, wherein the aperture forms an examination window below a patient; and
an imaging arm positioned below the examination window, wherein the imaging arm: is configured to securely receive an imaging transducer, is moveable in multiple degrees of freedom, and is upwardly spring-loaded such that the imaging arm, when positioned below a patient, is drawn upward to exert pressure onto the patient's body.

51. The integrated patient platform of claim 50, wherein the imaging arm is movable in six degrees of freedom.

52. The integrated patient platform of claim 51, further comprising a motor coupled to the imaging arm, wherein the motor is configured to drive automated position adjustment in at least one of the six degrees of freedom.

53. The integrated patient platform of claim 50, wherein at least two of the following orientations of the imaging arm are adjustable: pitch, gall, roll, vertical orientation, horizontal orientation, and angle.

54. The integrated patient platform of claim 50, wherein the imaging arm comprises a constant force spring to spring-load the imaging arm.

55. The integrated patient platform of claim 54, wherein the imaging arm is spring-loaded with 1-12 lbs. of force.

56. The integrated patient platform of claim 50, further comprising a lock configured to restrict each degree of freedom of the imaging arm and fix the orientation of the imaging arm in space.

57. The integrated patient platform of claim 56, wherein the imaging arm is configured to lock in a fixed position during operation of a treatment module,

58. The integrated patient platform of claim 50, further comprising the imaging transducer and a remote targeting monitor, wherein the imaging transducer is communicatively coupled to the remote targeting monitor,

59. The integrated patient platform of claim 58, wherein a virtual treatment region can be projected from the imaging transducer to the remote targeting monitor.

60. The integrated patient platform of claim 59, wherein the imaging transducer is removably coupled to the imaging arm.

61. The integrated patient platform of claim 50. further comprising an optical tracking camera.

62. The integrated patient platform of claim 61, wherein the imaging arm further comprises a first optical sensor disposed thereon, and wherein the optical tracking camera is configured to wirelessly communicate with the first optical sensor.

63. The integrated patient platform of claim 62, further comprising a therapy module, the therapy module having a second optical sensor disposed thereon, wherein the optical tracking camera is further configured to wirelessly communicate with the second optical sensor.

64. The integrated patient platform of claim 50, further comprising a therapy module, wherein the therapy module and the imaging arm are configured to be moveable together by a single operator.

65. The integrated patient platform of claim 64, wherein the therapy module is moveable via a motorized mechanism.

66. The integrated patient platform of claim 64, wherein the integrated patient platform is configured to communicate a relative position of the imaging transducer and the therapy module to enable positioning of the imaging transducer and the therapy module relative to one another.
